(19) United States
(12) Patent Application Publication
(10) Pub. No.: US 2009/0269269 A1
(43) Pub. Date: Oct. 29, 2009

(54) COPPER OXIDE NANOPARTICLE SYSTEM

(75) Inventors: Brian Edward White, Walton, NY (US); Stephen O'Brien, New York, NY (US)

Correspondence Address: SCHWEGMAN, LUNDBERG & WOESSNER, P.A., P.O. BOX 2938, MINNEAPOLIS, MN, 55402, US

(73) Assignee: The Trustees of Columbia University in City of New York, New York, NY (US)

(21) Appl. No.: 12/250,893

(22) Filed: Oct. 14, 2008

Related U.S. Application Data
(63) Continuation of application No. PCT/US2007/009637, filed on Apr. 20, 2007.
(60) Provisional application No. 60/793,959, filed on Apr. 20, 2006.
(60) Provisional application No. 60/831,381, filed on Jul. 17, 2006.
(60) Provisional application No. 60/860,284, filed on Nov. 21, 2006.

(51) Int. Cl. B01J 23/72; C01B 31/20

(52) U.S. Cl. 423/437.2; 502/345; 502/170; 502/165; 502/244; 502/346; 502/60; 502/318; 502/324; 502/331; 502/304; 977/902; 977/777

(57) ABSTRACT

The disclosed subject matter provides a copper oxide nanoparticle, a catalyst that includes the copper oxide nanoparticle, and methods of manufacturing and using the same. The catalyst can be used to catalyze a chemical reaction (e.g., oxidizing carbon monoxide (CO) to carbon dioxide (CO₂)).

### CROSS-REFERENCE TO RELATED APPLICATIONS

This application is a nationalization under 35 U.S.C. 371 of PCT/US2007/009637, filed Apr. 20, 2007 and published as WO 2007/136488 A2, on Nov. 29, 2007, which claimed priority under 35 U.S.C. 119(e) to U.S. Provisional Application Nos. 60/793,959, filed Apr. 20, 2006; 60/831,381, filed Jul. 17, 2006; and 60/860,284, filed Nov. 21, 2006; which applications and publication are incorporated herein by reference and made a part hereof.

### STATEMENT REGARDING FEDERALLY SPONSORED RESEARCH FOR DEVELOPMENT

The disclosed subject matter was made with United States government support under the Catalysis Futures grant DE-FG02-03ER15463 awarded by U.S. Department of Energy, Office of Basic Energy Sciences; under award number DMR-0213574 awarded by the MRSEC program of the National Science Foundation; under DMR-0348938 NSF-CAREER award awarded by the National Science Foundation; under award number CHE-0117752, NSF-CHE-04-15516 awarded by the NSEC program of the National Science Foundation and by the New York State Office of Science, Technology, and Academic Research (NYSTAR). The United States government may have certain rights in this invention.

### BACKGROUND

Catalytic processes are used across marry industries for a wide-range of applications, and will most likely play a pivotal role in the future of our energy sources, conversion methods, and environmental cleanliness. Rostrup Nielsen, J. R. Catalysis Reviews 2004, V46, 247-270. Without catalysts, many reactions would occur at very slow rates or not at all. George, S. M. Chemical Reviews (Washington, D.C.) 1995, 95, 475-6. Today, we realize the effects of catalysis in many industrial applications, for example, the refining of crude oil to produce gasoline, hydrocarbons, and other products, the conversion of harmful automobile exhaust into water, nitrogen, and carbon dioxide, the production of ammonia from nitrogen and hydrogen, the hydrogenation of fats in our food, the making of polymers used in plastics, all of which require the use of catalysts. Gates, B. C. Chem. Rev. 1995, 95, 511-522. As we push for less NOₓ, CO, SO₂, hydrocarbons, and other hanrnful gases being released into the environment, as well as decreasing our CO₂ output, we must look toward catalysis. Renewable energy efforts are also driven by the research of developing better, cheaper catalysts. Most heterogeneous catalysts are simple metals or metal oxides, such platinum for the oxidation of CO, but some can be very complex, like Mo₁₂BiFe₂NiCo₇MgSb0_{.9}Ti0_{.1}Te0_{.02}Cs_{0.4}Oₓ for the oxidation of isobutene to methacrolein. Hutchings, G. J. Catalysis Letters 2001, 75, 1-12. Future technologies are already relying on precious metals for their catalytic ability, but they are expensive and a limited supply. Other metals must be explored for their use in fuel cells, catalytic converters, and the pharmaceutical industry.

Nanoparticles offer a larger surface to volume ratio and a higher concentration of partially coordinated surface sites (e.g. edges, steps, and corners) than the corresponding bulk materials. The unique properties of nanoparticles are believed to be due to a strong interplay between elastic, geometric and electronic parameters, as well as the effects of interactions with the support. The result of these features is often improved physical and chemical properties compared to the bulk material. It is for these reasons that heterogeneous catalysis at nanoparticle surfaces is currently under intense investigation in the catalysis community at large. Haruta, MVI. Nature (London, U. K.) 2005, 437, 1098-1099 and Hutchings, G. J.; Haruta, M. Appl. Catal., A 2005, 291, 1-1.

The idea of nanoparticle catalysis is a bit confusing, because heterogeneous catalysis is a surface phenomenon where the reaction occurs at active sites and if more active sites are present, less material is needed. Knowing this, researchers have been reducing the size of catalysts as quickly as possible to save material and in turn keep costs down. But as stated previously, interesting effects start to occur when certain sizes are reached on the nanoscale. The best example of this is catalytically active nanogold, which is used in the oxidation of propene to its epoxide, the dehydrochlorination of chlorofluorocarbons, and other oxidation and hydrogenation reactions. Nanocatalysis; Heiz, U.; Landman, U., Eds.; Springer: Berlin, Heidelberg, New York, 2007.

In addition to their use in CO oxidation, Cu₂O nanoparticles have a potential application as a photocatalyst in solar cells due to their non-toxic nature, cheap abundance of the copper starting material, and low cost of synthesis and cell fabrication. Rai, B. P. Solar Cells 1988, 25, 265-272. Theoretical predictions place solar energy conversion efficiencies at over 18% when used in conjunction with ZnO, but only the bulk Cu₂O material has been studied, which is difficult to work with, so efficiency has only reached about 2%. Mittiga, A.; Salza, E.; Sarto, F.; Tucci, M.; Vasanthi, R. Applied Physics Letters 2006, 88, 163502/1-163502/2.

The oxidation of carbon monoxide (CO) to carbon dioxide (CO₂), i.e.,

2CO+O₂→2CO₂

appears to be a very simple, straightforward reaction, but it has been at the heart of catalysis research for decades. Ray, A. B.; Anderegg, F. O. Journal of the American Chemical Society 1921, 43, 967-78 and Santra, A. K.; Goodman, D. W. Electrochimica Acta 2002, 47, 3595-3609.

Carbon monoxide (CO) is a colorless, tasteless, odorless, harmful gas that is produced by the combustion of fossil fuels in cars, planes, furnaces and heaters, cigarettes, and some industrial processes. Inhalation of carbon monoxide (CO) gas can cause mild cardiovascular and neurobehavioral effects at low concentrations and unconsciousness and death at high concentrations or with prolonged exposures. Raub, J. A.; Mathieu-Nolf, M.; Hampson, N. B.; Thoin, S. R. Toxicology 2000, 145, 1-14. Removal of carbon monoxide (CO) from vehicle exhaust is important to keep levels in the environment low and the atmosphere clean. In 1975, the United States began to impose regulations limiting the amount of carbon monoxide (CO) a vehicle can emit. Rijkeboer, R. C. Catalysis Today 1991, 11, 141-50. This event sparked the invention of the catalytic converter, which contained the three-way catalyst (TWC): a catalyst system that can oxidize carbon monoxide (CO) and hydrocarbons and reduce nitric oxide. Kummer, J. T. Progress in Energy and Combustion Science 1980, 6, 177-199. With the introduction of the catalytic converter, the entire gas economy moved from leaded gasoline to unleaded gasoline due to catalyst poisoning by the lead and its harmful effects on the environment. Traditionally the TWC has been comprised of noble metals: platinum, palladium, and/or rhodium mixed with cerium dioxide, CeO₂, and supported on a high surface area ceramic or metal structure. Kummer, J. T. Progress in Energy and Combustion Science 1980, 6, 177-199. Carbon monoxide (CO) oxidation over platinum is possibly the most well understood catalytic reaction, but the use of platinum catalysts is hindered by supply and cost. Santra, A. K.; Goodman, D. W. Electrochimica Acta 2002, 47, 3595-3609.

Recently, small clusters and nanoparticles of gold were found to oxidize carbon monoxide (CO) at relatively low temperatures when they were supported on transition metal oxides. Haruta, M.; Yamada, N.; Kobayashi, T.; Iijima, S. Journal of Catalysis 1989, 115, 301-309 and Haruta, M.; Date, M. Applied Catalysis, A: General 2001, 222, 427-437. High conversions of carbon monoxide (CO) to carbon dioxide (CO₂) can be obtained over nanosized gold at temperatures as low as 200 K, where the best support is titanium dioxide, which alone is not an active catalyst, but the synergistic effect between the TiO₂ and the gold is extremely active. Haruta, M.; Date, M. Applied Catalysis, A: General 2001, 222, 427-437. In the presence of moisture the catalytic activity of gold actually increases, whereas most catalysts are hindered by water. Nanocatalysis; Heiz, U.; Landman, U., Eds.; Springer: Berlin, Heidelberg, New York, 2007. Much the carbon monoxide (CO) oxidation work thus far has been based on precious metals, which are expensive and recognized as a scarce resource as well as a limiting step in the development of viable energy alternatives to petroleum. Any ncw system that overcomes these limitations will be invaluable.

The Cu—Cu₂O—CuO system has been known to facilitate oxidation reactions in the bulk, which may allow it to be a cost-effective substitute for noble metals in various catalytic systems. Huang, T.-J.; Tsai, D.-H. Catal. Lett. 2003, 87, 173-178; Jernigan, G. G.; Somoijai, G. A. J. Catal. 1994, 147, 567-77; and Somorjai, G. A.; Jernigan, G. J. Catal. 1997, 165, 284. In previous studies of thin films and bulk powders, the proposed mechanism of conversion of CO to CO₂ on a CuO surface is a redox cycle involving the reduction of Cu²⁺ to Cu⁺ by CO. Oxygen is then supplied from the surface of the copper oxide and reacts with the CO to form CO². Huang, T.-J.; Tsai, D.-H. Catal. Lett. 2003, 87, 173-178; Jernigan, G. G.; Somorjai, G. A. J. Catal. 1994, 147, 567-77; Park, P. W.; Ledford, J. S. Catal. Lett. 1998, 50, 41-48; and Rao, G. R.; Sahu, H. R.; Mishra, B. G. Colloids Surf., A 2003, 220, 261-269.

In reactions containing close to stoichiometric ratios of CO and O₂, the Cu⁰ was quickly oxidized to Cu₂O and then CuO, which both have lower activation energies toward CO oxidation than Cu⁰, and therefore are more favored in low ratios of CO to O₂. Jernigan, G. G.; Somorjai, G. A. J. Catal. 1994, 147, 567-77. Tsai et al (Huang, T.-J.; Tsai, D.-H. Catal. Lett. 2003, 87, 173-178) studied the activity of Cu, CU₂O, and CuO bulk powders in oxygen-rich and oxygen-lean atmospheres. They showed that oxygen concentration, the initial oxidation state of the catalyst, and temperature are all significant factors surrounding the oxidation of carbon monoxide by copper.

Conventionally supported catalysts are generally produced by impregnation of a support medium with the desired metal ions followed by thermal treatments that result in small and dispersed active catalytic sites. Park, P. W.; Ledford, J. S. Catal. Lett. 1998, 50, 41-48 and Chiang, C. W.; Wang, A.; Wan, B. Z.; Mou, C. Y. J. Phys. Chem. B 2005, 109, 18042-18047. However, the small catalyst particles are not uniform and there is little control over their size.

### BRIEF DESCRIPTION OF THE DRAWINGS

Embodiments of the disclosed subject matter may be best understood by referring to the following description and accompanying drawings which illustrate such embodiments. The numbering scheme for the Figures included herein are such that the leading number for a given reference number in a Figure is associated with the number of the Figure. For example, a chart diagram depicting the redispersing (115) can be located in FIG. 13. In the drawings:

FIG. 1 illustrates a diagram of flatbed continuous flow reactor.

FIG. 2 illustrates conversion rates of CO to CO₂ for various types of copper and copper oxides without and with silica gel run at 240° C. in 93% N₂, 3% O₂, and 4% CO.

FIG. 3 illustrates the thermogram and derivative of Cu₂O nanoparticles as synthesized.

FIG. 4 illustrates X-ray powder diffraction patterns of the catalyst system at various stages.

FIG. 5 illustrates oxygen concentration dependence for CO oxidation over 10 mg of 10 nm Cu₂O nanoparticles supported on 75 mg silica in 4% CO and 20% O₂, 14% O₂, 3% O₂, and 1% O₂. with a balance of N₂.

FIG. 6 illustrates conversion of CO to CO₂ by 10 mg of 10 nm Cu₂O nanoparticles on 75 mg silica.

FIG. 7 illustrates light-off temperature results for the oxidation of carbon monoxide in the continuous flow reactor over 10 mg of 10 nm Cu₂O nanoparticle supported on 75 mg silica gel.

FIG. 8 illustrates a proposed CO oxidation redox reaction on Cu₂O nanoparticles.

FIG. 9 illustrates calculated energetics for CO landing on a surface oxygen atom, on a Cu atom, and for CO₂ departure from the surface.

FIG. 10 illustrates conversion of CO to CO₂ by 10 mg of 10 nm Cu₂O nanoparticles on 75 mg silica. And the conversion of CO to CO₂ by 10 mg of 10 nm Cu₂O nanoparticles and 8 mg of 6 nm CeO₂ nanoparticles on 75 mg silica.

FIG. 11 illustrates the wt % loading dependence of 6 mn CeO₂ nanoparticles on the conversion of CO to CO₂ by 10 mg of 10 nm Cu₂O nanoparticles on 75 mg silica. Additionally it illustrates the diameter dependence of CeO₂ nanoparticles on the conversion of CO to CO₂ by 10 mg of 10 nmn Cu₂ nanoparticles on 75 mg silica using 9 wt % loading of CeO₂ nanoparticles.

FIG. 12 illustrates a conversion percentage versus time, of a catalyst as described in published U.S. Patent Application US 2004/0110633; and a catalyst of the presently disclosed subject matter.

FIG. 13 illustrates a chart diagram depicting methods to manufacture copper oxide nanoparticles of the disclosed subject matter.

FIG. 14 illustrates a chart diagram depicting methods to manufacture a catalyst of the disclosed subject matter, which is a Cu^{o}—Cu₂O—CuO nanoparticle supported on a spacer.

### SUMMARY

The disclosed subject matter provides a nanoparticle system that includes a copper oxide nanoparticle and a spacer. The copper oxide nanoparticle is dispersed or supported upon the surface of the spacer. The copper oxide nanoparticle includes a core that includes crystalline cuprous oxide (Cu₂O), and a shell of amorphous cupric oxide (CuO). The shell of amorphous cupric oxide (CuO) is present on at least a portion of the surface of the core.

The disclosed subject matter also provides a catalyst that includes a copper oxide nanoparticle, optionally a surfactant present on at least a portion of the surface of the copper oxide nanoparticle, and a spacer in which the copper oxide nanoparticle is dispersed or supported upon the surface thereof. The copper oxide nanoparticle includes a core that includes copper-cuprous oxide (Cu⁰—Cu₂O), and cupric oxide (CuO). The cupric oxide (CuO) is present on at least a portion of the surface of the core.

The disclosed subject matter also provides a method for oxidizing carbon monoxide (CO) to carbon dioxide (CO₂). The method includes contacting a gaseous mixture that includes carbon monoxide (CO) and oxygen (O₂), with a catalyst of the disclosed subject matter.

The disclosed subject matter also provides a method for catalyzing a chemical reaction. The method includes contacting starting material of the chemical reaction with a catalyst of the disclosed subject matter, under suitable conditions effective to catalyze the reaction.

The disclosed subject matter also provides a method for manufacturing a catalyst. The method includes contacting a spacer with a nanoparticle to form a catalyst precursor, drying the catalyst precursor to provide a dried catalyst precursor, and heating the dried catalyst precursor, to provide the catalyst. The nanoparticle includes: a copper oxide nanoparticle and a ligand which coats the copper oxide nanoparticle. The copper oxide nanoparticle includes a core that includes crystalline cuprous oxide (Cu₂O), and a shell of amorphous cupric oxide (CuO). The shell of amorphous cupric oxide (CuO) is present on at least a portion of the surface of the core.

The nanoparticle can be prepared by contacting copper acetate, oleic acid and trioctylamine, and heating to provide thermally decomposed the copper acetate; cooling the thermally decomposed copper acetate to provide cooled particles; contacting the cooled particles with a solvent; separating to provide precipitated copper oxide nanoparticles, and redispersing the precipitated copper oxide nanoparticles.

### DETAILED DESCRIPTION

The disclosed subject matter provides nanoparticle systems that include cooper oxide nanoparticles of various sizes, as well as methods of manufacturing the same. The copper oxide nanoparticles have suitable surface (m²/g) to volume (mL) ratios (e.g., at least about 250 to about 1500). The copper oxide nanoparticles can have a narrow size distribution. Specifically, the copper oxide nanoparticles can be monodisperse (i.e., the root mean square deviation from the diameter is less than about 10%), or they can be highly monodisperse (i.e., the root mean square deviation from the diameter is less than about 5%). The nanocrystal size can be controlled by the temperature, time allowed for growth, and/or the subsequent addition of ligands.

The methods of the disclosed subject matter can produce copper oxide nanoparticles identical in crystal structure and almost identical in size, which can be dispersed in solvents and transferred to other media relatively easily with minimal agglomeration on surfaces. The methods of synthesizing copper oxide nanoparticles prior to impregnation allows one to create copper oxide nanoparticles of a specific and relatively uniform diameter, and then add them to the support material. The uniformity or monodispersity is important for the preparation of the active catalyst species. For example, monodispersity of the copper oxide nanoparticles contributes to the preparation of a highly uniform and active catalyst over the support.

The disclosed subject matter also provides methods and systems that employ the copper oxide nanoparticles loaded onto a support material, as a catalyst toward carbon monoxide (CO) oxidation at relatively low temperatures. The catalyst can convert monoxide (CO) oxidation contained within a gas stream that also contains oxygen (O₂).

The catalyst includes Cu₂O nanoparticles loaded onto a support material. The catalyst carries out relative efficient oxidation of CO to CO₂. The active catalyst structure is thought to be a mix of crystalline Cu²⁺ and Cu⁺ obtained through a redox reaction between the two states. The presence of the support material extends the lifetime of the nanoparticles, by minimizing or diminishing the occurrence of sintering, which decreases the effective surface area. The Cu₂O nanoparticle system oxidizes CO to CO₂ for over 144 hours with relatively little or no dependence on O₂ concentration. The catalyst is a cost effective, highly efficient alternative to current CO oxidation systems, thus opening the doorway to a variety of applications requiring cheap one-time use or short timeframe catalysts for oxidizing CO to CO₂.

As such, the disclosed subject matter provides a relatively inexpensive and effective method of using copper oxide nanoparticles, loaded onto a support material, as an exceptional catalyst toward CO oxidation at relatively low temperatures. Over sustained periods of time, conversions of 99.5% of CO to CO₂ are routinely observed and the catalyst structure is retained during the reaction. Additionally, the catalysts of the disclosed subject matter possess relatively long lifetimes (e.g., up to about 220 hours).

The catalysts of the disclosed subject matter can work at a very high flow rate, averaging >99.5% CO conversion at 80,000 hr⁻¹ and >90% CO conversion at 150,000 hr⁻¹ over 120 hours.

The catalysts of the disclosed subject matter oxidize over 70% of CO in a 65% H₂ stream, leaving over 70% of the H₂ alone. If this were used in a tandem system, utilizing a two stage process, over 90% of the CO could be oxidized. This is significant because preferential oxidation of CO in a hydrogen gas flow (PROX) is important for such application as the post-processing of Syngas to produce hydrogen as an energy source for use in fuel cells. A byproduct of this reaction is CO; however, trace amounts of CO (>50 ppm) can poison a fuel cell electrode, drastically reducing its efficiency. Carbon monoxide (CO) is detrimental to the operation of current fuel cells because at levels greater than 50 ppm, it can poison the platinum catalyst, rendering the fuel cell less efficient or inoperable.

Reference will now be made in detail to certain claims of the disclosed subject matter, examples of which are illustrated below. While the disclosed subject matter will be described in conjunction with the enumerated claims, it will be understood that they are not intended to limit the disclosed subject matter to those claims. On the contrary, the disclosed subject matter is intended to cover all alternatives, modifications, and equivalents, which may be included within the scope of the disclosed subject matter as defined by the claims.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The disclosed subject matter relates to nanoparticles, nanoparticle systems, catalysts, as well as methods of making and using the same. When describing the nanoparticles, nanoparticle systems, catalysts, and methods of making and using the same, the following terms have the following meanings, unless otherwise indicated.

### Definitions

Unless stated otherwise, the following terms and phrases as used herein are intended to have the following meanings:

As used herein, “nanoparticle” refers to is a microscopic particle with at least one dimension less than 100 nm.

As used herein, “crystalline” or “morphous” refers to solids in which there is long-range atomic order of the positions Of the atoms.

As used herein, “cuprous oxide” or “copper(I) oxide” refers to Cu₂O, which is an oxide of copper.

As used herein, “amorphous” refers to a solid in which there is no long-range order of the positions of the atoms.

As used herein, “cupric oxide” or “copper(II) oxide” refers to CuO.

As used herein, “disperse” refers to the act of introducing solid particles in a liquid, such that the particles separate uniformly throughout the liquid.

As used herein, “core” refers to the central, innermost region of the nanoparticles described herein.

As used herein, “shell” refers to the outermost region or layer of the nanoparticles described herein.

As used herein, “spacer” or “support material” refers to any suitable material that is not part of the catalyst, but can be used to stabilize and disperse the catalyst throughout the catalytic reaction.

As used herein, “monodisperse” refers to a narrow size distribution, such that the root mean square deviation from the diameter is less than about 10%.

As used herein, “highly monodisperse” refers to a narrow size distribution, such that the root mean square deviation from the diameter is less than about 5%.

As used herein, “surfactant” or “surface active agent” refers to wetting agents that lower the surface tension of a liquid, allowing easier spreading, and lower the interfacial tension between two liquids. Surfactants are typically classilied into tour primary groups; anionic, cationic, non-ionic, and zwitterionic (dual charge). A nonionic surfactant has no charge groups in its head. The head of an ionic surfactant carries a net charge. If the charge is negative, the surfactant is more specifically called anionic; if the charge is positive, it is called cationic. If a surfactant contains a head with two oppositely charged groups, it is termed zwitterionic.

As used herein, “(C₁₀-C₃₀) alkyl” refers to a C₁₀-C₃₀ hydrocarbon containing normal, secondary or tertiary carbon atoms. Examples include, e.g., 1-decanyl, 1-undecanyl, 1-dodecanyl, 2-decanyl, 2-undecanyl, and 3-dodecanyl.

As used herein, “(C₁₀-C₃₀) alkenyl” refers to a hydrocarhon containing normal, secondary or tertiary carbon atoms with at least one site of unsaturation, i.e. a carbon-carbon, sp² double bond. Examples include, but are not limited to (E)-10-dec-4-enyl, (E)-10-undec-4-enyl, and (E)-10-dodec-4-enyl.

As used herein, “(C₁₀-C₃₀) cycloalkyl” refers to multiple, condensed ring structures of cyclic alkyl groups, each of from 3 to 20 carbon atoms. Such cycloalkyl groups include, e.g., adamantanyl, triterpenoids, and the like.

As used herein, “substituted” is intended to indicate that one or more hydrogens on the atom indicated in the expression using “substituted” is replaced with a selection from the indicated group(s), provided that the indicated atom's normal valency is not exceeded, and that the substitution results in a stable compound. Suitable indicated groups include, e.g., alkyl, alkenyl, alkylidenyl, alkenylidenyl, alkoxy, halo, haloalkyl, hydroxy, hydroxyalkyl, aryl, heteroaryl, heterocycle, cycloalkyl, alkanoyl, acyloxy, alkoxycarbonyl, amino, imino, alkylamino, acylamino, nitro, trifluoromethyl, trifluoromethoxy, carboxy, carboxyalkyl, keto, thioxo, alkylthio, alkylsulfinyl, alkylsulfonyl, cyano, acetamido, acetoxy, acetyl, benzamido, benzenesulfinyl, benzenesulfonamido, benzenesul fonyl, benzenesulfonylamino, benzoyl, benzoylamino, benzoyloxy, benzyl, benzyloxy, benzyloxycarbonyl, benzylthio, carbamoyl, carbamate, isocyannato, sulfamoyl, sulfinamoyl, sulfino, sulfo, sulfoamino, thiosulfo, NR^{x}R^{y} and/or COOR^{x}, wherein each R^{x} and R^{y} are independently H, alkyl, alkenyl, aryl, heteroaryl, heterocycle, cycloalkyl or hydroxy. When a substituent is keto (i.e., ═O) or thioxo (i.e., ═S) group, then 2 hydrogens on the atom are replaced.

As used herein “suitable salt” refers to ionic compounds wherein a parent non-ionic compound is modified by making acid or base salts thereof. Examples of suitable salts include, but are not limited to, mineral or organic acid salts of basic residues such as amines; alkali or organic salts of acidic residues such as carboxylic acids; and the like.

As used herein, “oleic acid” refers to a monounsaturated omega-9 fatty acid found in various animal and vegetable sources. It has the formula C₁₈H₃₄O₂ (or CH₃(CH₂)₇CH═CH(CH₂)₇COOH).

As used herein, “lauric acid” or “dodecanoic acid” refers to a saturated fatty acid with the structural formula CH₃(CH₂)₁₀COOH.

As used herein, “octanoic acid” or “caprylic acid” refers to CH₃(CH₂)₆COOH.

As used herein, “stearic acid” or “octadecanoic acid” refers to CH₃(CH₂)₁₆COOH.

As used herein, “1-octadecanol” or “stearyl alcohol” refers to CH₃(CH₂)₁₇OH.

As used herein, “claidic acid” or “trans-9-octadecenoic acid” refers to CH₃(CH₂)₇CH═CH(CH₂)₇COOH.

As used herein, “2-acetyl pyridine” refers to a compound of the formula:

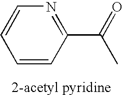

As used herein, “p-anisaldehyde” refers to a compound of the formula:

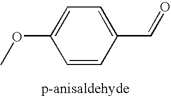

As used herein, “butyrolactone” refers to a compound of the formula:

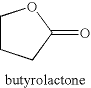

As used herein, “1-formyl piperidine” refers to a compound of the formula:

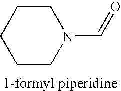

As used herein, “ethylene carbonate,” “1,3-dioxolan-2-one” or “ethylene glycol carbonate” refers to a compound of the formula:

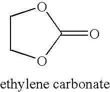

As used herein, “propylene carbonate,” “carbonic acid propylene ester,” “cyclic 1,2-propylene carbonate,” “propylene glycol cyclic carbonate,” “1,2-propanediol carbonate,” or “4-methyl-2-oxo-1,3-dioxolane” refers to a compound of the formula:

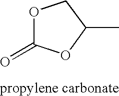

As used herein, “gamma-buytrolactone” refers to a compound of the formula:

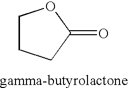

As used herein, “catechols” or “pyrocatechol” refers to benzene-1,2-diol, which is a compound of the formula:

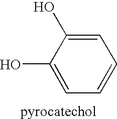

As used herein, “benzylamine oleylamine” refers to a compound of the formula:

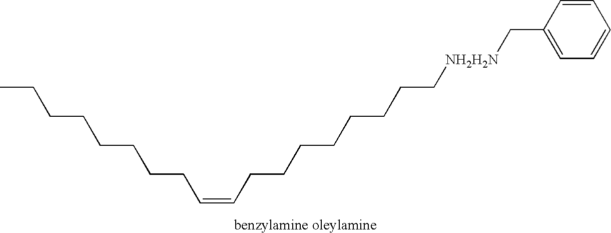

As used herein, “silica gel” refers to a granular, porous form of silica typically made synthetically from sodium silicate. Despite the name, silica gel is a solid.

As used herein, “alumina” or “aluminum oxide” refers to a chemical compound of aluminum and oxygen with the chemical formula Al₂O₃.

As used herein, “zeolite” refers to minerals that have a micro-porous structure. More than 150 zeolite types have been synthesized and 48 naturally occun-ing zeolites are known. They are basically hydrated alumino-silicate minerals with an “open” structure that can accommodate a wide variety of cations, such as Na⁺, K⁺, Ca²⁺, Mg²⁺ and others. These positive ions are rather loosely held and can readily be exchanged for others in a contact solution. Some of the more common mineral zeolites are: analcime, chabazite, heulandite, natrolite, phillipsite, and stilbite.

As used herein, “inert gas” refers to any gas that is not reactive under normal circumstances. Unlike the noble gases, an inert gas is not necessarily elemental and are often molecular gases. Like the noble gases, the tendency for non-reactivity is due to the valence, the outermost electron shell, being complete in all the inert gases.

As used herein, “starting materials” or “starting materials of a chemical reaction” refers to those substances (i.e., compounds) that undergo a chemical transformation, under the specified conditions (e.g., time and temperature) and with the specified reagents and/or catalysts described therein.

As used herein, “hydrocarbon” refers to a compound that is composed exclusively of carbon and hydrogen. The hydrocarbon can be branched or straight-chained, can be saturated, unsaturated or partially unsaturated, and can be acyclic or cyclic, wherein the cyclic hydrocarbon can be aromatic or non-aromatic.

As used herein, “coupling” refers to the act of joining, pairing or otherwise unitinig two compounds (or a derivative thereof), via chemical means (i.e., via a chemical reaction). An example is the Ullmann reaction or Ullmann coupling between two aryl halides, with copper as the reagent.

As used herein, “aryl halide” refers to an organic compound in which a halogen atom is bonded to a carbon atom which is part of an aromatic ring.

As used herein, “aromatic ring” refers to an unsaturated aromatic carbocyclic group of from 6 to 20 carbon atoms having a single ring (e.g., phenyl) or multiple condensed (fused) rings, wherein at least one ring is aromatic (e.g., naphthyl, dihydrophenanthrenyl, fluorenyl, or anthryl). Specific aromatic rings include phenyl, naphthyl and the like.

As used herein, “Ullmann coupling” or “Ullmann coupling” refers to a coupling reaction between aryl halides with copper. A typical example is the coupling of 2 molar equivalents o-chloronitrobenzene, with a copper-bronze alloy, to provide 1 molar equivalent of 2,2′-dinitrobiphenyl.

As used herein, “contacting” refers to the act of touching, making contact, or of immediate proximity.

As used herein, “drying” includes removing a substantial portion (e.g., more than about 90 wt. %, more than about 95 wt. % or more than about 99 wt. %) of organic solvent and/or water present therein.

As used herein, “heating” refers to the transfer of thermal energy via thermal radiation, heat conduction or convection, such that the temperature of the object that is heated increases over a specified period of time.

As used herein, “cerium(IV) oxide”, “ceric oxide,” “ceria,” “cerium oxide” or “cerium dioxide” refers to CeO₂.

As used herein, “room temperature” refers to a temperature of about 18° C. (64° F.) to about 22° C. (72° F.).

As used herein, “agitating” refers to the process of putting a mixture into motion with a turbulent force. Suitable methods of agitating include, e.g., stirring, mixing, and shaking.

As used herein, “atmospheric air” refers to the gases surrounding the planet Earth and retained by the Earth's gravity. Roughly, it contains nitrogen (75%), oxygen (21.12%), argon (0.93%), carbon dioxide (0.04%), carbon monoxide (0.07%), and water vapor (2%).

As used herein, “cooling” refers to transfer of thermal energy via thermal radiation, heat conduction or convection, such that the temperature of the object that is cooled decreases over a specified period of time.

As used herein, “polar solvent” refers to solvents that exhibit polar forces on solutes, due to high dipole moment, wide separation of charges, or tight association; e.g., water, alcohols, and acids. The solvents typically have a measurable dipole. Such solvents will typically have a dielectric constant of at least about 15, at least about 20, or between about 20 and about 30.

As used herein, “non-polar solvent” refers to a solvent having no measurable dipole. Specifically, it refers to a solvent having a dielectric constant of less than about 15, less than about 10, or between about 6 and about 10.

As used herein, “alcohol” includes an organic chemical containing one or more hydroxyl (OH) groups. Alcohols can be liquids, semisolids or solids at room temperature. Common mono-hydroxyl alcohols include, e.g., ethanol, methanol and propanol. Common poly-hydroxyl alcohols include, e.g., propylene glycol and ethylene glycol.

As used herein, “centrifuging” or “centrifugation” includes the process of separating fractions of systems in a centrifuge. The most basic separation is to sediment a pellet at the bottom of the tube, leaving a supernatant at a given centrifugal force. In this case sedimentation is determined by size and density of the particles in the system amongst other factors. Density may be used as a basis for sedimentation in density gradient centrifugation, at verys high g values molecules may be separated, i.e. ultra centrifugation. In continuous centrifugation the supernatant is removed continuously as it is formed. It includes separating molecules by size or density using centrifugal forces generated by a spinning rotor. G-forces of several hundred thousand times gravity are generated in ultracentrifugation. Centrifuging effectively separates the sediment or precipitate from the fluid.

As used herein, “redispersing” refers to the act of introducing solid particles in a liquid, such that the particles separate uniformly throughout the liquid.

As used herein, “protic solvent” refers to a solvent that contains a dissociable H⁺ ion. Typically, the solvent carries a hydrogen bond between an oxygen (as in a hydroxyl group) or a nitrogen (as in an amine group).

As used herein, “aprotic solvent” refers to a solvent that lacks a dissociable H⁺ ion.

As used herein, “co-catalyst” refers to one or more catalysts that can be used in combination with a copper oxide catalyst of the disclosed subject matter. In specific embodiments of the disclosed subject matter, such co-catalysts include, e.g.,

chromium (Cr) (see, Agudo, A. L.; Palacios, J. M.; Fierro, J. L. G.; Laine, J.; Severino, F. Applied Catalysis, A. General 1992, 91, 43-55; Kapteijn, F.; Stegenga, S.; Dekker, N. J. J.; Bijsterbosch, J. W.; Moulijn, J. A. Catalysis Today 1993, 16, 273-87; Misono, M.; Hirao, Y.; Yokoyama, C. Catalysis Today 1997, 38, 157-162; Park, P. W.; Ledford, J. S. Industrial & Engineering Chemistry Research 1998, 37, 887-893; Zaki, M. I.; Hasan, M. A.; Pasupulety, L. Applied Catalysis, A: General 2000, 198, 247-259; Parvulescu, V.; Anastasescu, C.; Su, B. L. Journal of Molecular Catalysis A: Chemical 2004, 211, 143-148; and Trinm, D. L. Applied Catalysis, A: General 2005, 296, 1-11);

nickel (Ni) (see, Kapteijn, F.; Stegenga, S.; Dekker, N. J. J.; Bijsterbosch, J. W.; Moulijn, J. A. Catalysis Today 1993, 16, 273-87; Parvulescu, V.; Anastasescu, C.; Su, B. L. Journal of Molecular Catalysis A: Chemical 2004, 211, 143-148; and Li, Y.; Fu, Q.; Flytzani-Stephanopoulos, M. Applied Catalysis, B: Environmental 2000, 27, 179-191);

cobalt (Co) (see, Kapteijn, F.; Stegenga, S.; Dekker, N. J. J.; Bijsterbosch, J. W.; Moulijn, J. A. Catalysis Today 1993, 16, 273-87; and Parvulescu, V.; Anastasescu, C.; Su, B. L. Journal of Molecular Catalysis A: Chemical 2004, 211, 143-148);

iron (Fe) (see, Agudo, A. L.; Palacios, J. M.; Fierro, J. L. G.; Laine, J.; Severino, F. Applied Catalysis, A: General 1992, 91, 43-55; Kapteijn, F.; Stegenga, S.; Dekker, N. J. J.; Bijsterbosch, J. W.; Moulijn, J. A. Catalysis Today 1993, 16, 273-87; Zaki, M. I.; Hasan, M. A.; Pasupulety, L. Applied Catalysis, A: General 2000, 198, 247-259; Ford, P. C.; Rinker, R. G.; Ungermann, C.; Laine, R. M.; Landis, V.; Moya, S. A. Journal of the American Chemical Society 1978, 100, 4595-4597; Oh, S. H.; Eickel, C. C. Journal of Catalysis 1988, 112, 543-555; Bunluesin, T.; Gorte, R. J.; Graham, G. W. Applied Catalysis, B. Environmental 1998, 15, 107-114; Centi, G.; Perathoner, S. Topics in Catalysis 2001, 15, 145-152; Li, P.; Miser, D. E.; Rabiei, S.; Yadav, R. T.; Hajaligol, M. R. Appl. Catal., B 2003, 43, 151-162; Szegedi, A.; Hegedus, M.; Margitfalvi, J. L.; Kiricsi, I. Chem Commun (Camb) 2005, 1441-3;

manganese (Mn) (see, Misono, M.; Hirao, Y.; Yokoyama, C. Catalysis Today 1997, 38, 157-162; Zaki, M. I.; Hasan, M. A.; Pasupulety, L. Applied Catalysis, A: General 2000, 198, 247-259; Parvulescu, V.; Anastasescu, C.; Su, B. L. Journal of Molecular Catalysis A: Chemical 2004, 211, 143-148; Kanungo, S. B. Journal of Catalysis 1979, 58, 419-35; Imamura, S.; Tsuji, Y.; Miyake, Y.; Ito, T. Journal of Catalysis 1995, 151, 279-84; Hutchings, G. J.; Mirzaei, A. A.; Joyner, R. W.; Siddiqui, M. R. H.; Taylor, S. H. Appl. Catal., A 1998, 166, 143-152; Ferrandon, M.; Carno, J.; Jaras, S.; Bjombom, E. Applied Catalysis, A. General 1999,180, 153-161; Stobbe, E. R.; de Boer, B. A.; Geus, J. W. Catalysis Today 1999, 47, 161-167; Buciumran, F. C.; Patcas, F.; Hahn, T. Studies in Surface Science and Catalysis 2001, 138, 315-322; Yin, M.; O'Brien, S. Journal of the American Chemical Society 2003, 125, 10180- 10181; Maier, W. F.; Saalfrank, J. Chemical Engineering Science 2004, 59, 4673-4678; Solsona, B.; Hutchings, G. J.; Garcia, T.; Taylor, S. H. New Journal of Chemistry 2004, 28, 708-711; Marban, G.; Fuertes, A. B. Applied Catalysis, B: Environmental 2005, 57, 43-53; Han, Y. F.; Chen, F.; Zhong, Z.; Ramesh, K.; Chen, L.; Widjaja, E. J Phys Chem B Condens Matter Mater Surf Interfaces Biophys 2006;

platinum (Pt) (see, Ferrandon, M.; Carno, J.; Jaras, S.; Bjornbom, F. Applied Catalysis, A. General 1999, 180, 153-161; Serre, C.; Garin, F.; Belot, G.; Maire, G. Journal of Catalysis 1993, 141, 9-20; Somorjai, G. A. Surface Science 1994, 299-300, 849-66; Santra, A. K.; Goodman, D. W. Electrochimica Acta 2002, 47, 3595-3609; McCrea, K. R.; Parker, J. S.; Somorjai, G. A. J. Phys. Chem. B 2002, 106, 10854-10863;

palladium (Pd) (see, Imamura, S.; Tsuji, Y.; Miyake, Y.; Ito, T. Journal of Catalysis 1995, 151, 279-84; Lee, J. S.; Park, E. D.; Song, B. J. Catalysis Today 1999, 54, 57-64; Hungria, A. B.; Iglesias-Juez, A.; Martinez-Arias, A.; Fernandez-Garcia, M.; Anderson, J. A.; Conesa, J. C.; Soria, J. Journal of Catalysis 2002, 206, 281-294; Gong, Y.; Hou, Z.; Xin, H. Journal of Physical Chemistry B 2004, 108, 17796-17799; Rosso, I.; Galletti, C.; Saracco, G.; Garrone, E.; Specchia, V. Applied Catalysis, B: Environmental 2004. 48, 195-203;

rhodium (Rh) (see, Oh, S. H.; Eickel, C. C. Journal of Catalysis 1988, 112, 543-555; Bunluesin, T.; Gorte, R. J.; Graham, G. W. Applied Catalysis, B: Environmental 1998, 15, 107-114; Szanyi, J.; Goodman, D. W. J. Catal. 1994, 145, 508-15;

iridium (Ir); and

gold (Au) (see, Haruta, M.; Yamada, N.; Kobayashi, T.: Iijima, S. Journal of Catalysis 1989, 115, 301-309; Liu, W.; Flytzanistephanopoulos, M. Journal of Catalysis 1995, 153, 317-332; Liu, J.-H.; Chi, Y.-S.; Lin, H.-P.; Mou, C.-Y.; Wan, B.-Z. Catalysis Today 2004, 93-95, 141-147; Haruta, M. Nature 2005, 437, 1098-1099; Guzman, J.; Carrettin, S.; Fierro-Gonzalez, J. C.; Hao, Y.; Gates, B. C.; Corma, A. Angew Chem Int Ed Engl 2005, 44, 4778-81; Chiang, C. W.; Wang, A.; Wan, B. Z.; Mou, C. Y. Journal of Physical Chemistry B 2005, 109, 18042-18047; Xu, C.; Su, J.; Xu, X.; Liu, P.; Zhao, H.; Tian, F.; Ding, Y. J Am Chem Soc 2007, 129, 42-3.

The catalyst of the disclosed subject matter, alone or in combination with a suitable co-catalyst, can effectively and efficiently catalyze the oxidation of carbon monoxide (CO) to carbon dioxide (CO₂). Additionally, the catalyst of the disclosed subject matter, alone or in combination with a suitable co-catalyst, can effectively and efficiently catalyze the reduction of NOₓ, (see, Kapteijn, F.; Stegenga, S.; Dekker, N. J. J.; Bijsterbosch, J. W.; Moulijn, J. A. Catalysis Today 1993, 16, 273-87; Misono, M.; Hirao, Y.; Yokoyama, C. Catalysis Today 1997, 38, 157-162; Jeong, J.-W.; Choi, B.-C. JSME International Journal, Series B: Fluids and Thermal Engineering 2002, 45, 392-398; Kuznetsova, T. G.; Sadykov, V. A.; Sorokina, T. P.; Doronin, V. P.; Alikina, G. M.; Bunina, R. V.; Ivanova, A. S.; Matyshak, V. A.; Konin, G. A.; Rozovskii, A. Y.; Burdeinaya, T. N.; Tret'yakov, V. F.; Ross, J.; (Institut Kataliza im. G. K. Boreskova SO RAN, Russia). Application: RU, 2002, p No pp given; Deen, R.; Scheltus, P. I. T.; De Vries, G. Journal of Catalysis 1976, 41, 218-26; Jiang, X.; Ding, G.; i.ou, L..; Chen, Y.; Zheng, X. Catalysis Today 2004, 93-95, 811-818);

the reduction of SO₂ (see, Liu, W.; Sarofim, A. F.; Flytzani-Stephanopoulos, M. Applied Catalysis, B: Environmental 1994, 4, 167-186) and

the oxidation of hydrocarbons (see, Yao, Y.-F. Y. Journal of Catalysis 1984, 87, 152-162; Carberry, J. J. Accounts of Chemical Research 1985, 18, 358-63; Ludykar, D.; Westerholm, R.; Almen, J. Science of the Total Environment 1999, 235, 65-69; Rostovshchikova, T. N.; Smirnov, V. V.; Kozhevin, V. M.; Yavsin, D. A.; Gurevich, S. A. Kinetics and Catalysis (Translation of Kinetika i Kataliz) 2003, 44, 555-561).

The catalyst of the disclosed subject matter, alone or in combination with a suitable co-catalyst, can effectively and efficiently catalyze reactions in organic synthesis, such as the Ullmann coupling (see, Ponce, A. A.; Klabunde, K. J. Journal of Molecular Catalysis A: Chemical 2005, 225, 1-6; and Son, S. U.; Park, I. K.; Park, J.; Hyeon, T. Chemical Communications (Cambridge, United Kingdom) 2004, 778-779).

### Nanoparticle System

The nanioparticle system of the disclosed subject matter includes: (a) a copper oxide nanoparticle that includes: (i) a core that includes crystalline cuprous oxide (Cu₂O); and (ii) a shell of amorphous cupric oxide (CuO) present on at least a portion of the surface of the core; and (b) a spacer, in which the copper oxide nanoparticle is dispersed or supported upon the surface thereof.

In specific embodiments of the disclosed subject matter, the nanoparticle system has a surface (m²/g) to volume (mL) ratio of at least about 250 to about 1500.

### Copper Oxide Nanoparticle

As stated above, the copper oxide nanoparticle of the disclosed subject matter includes: (i) a core that includes crystalline cuprous oxide (Cu₂O); and (ii) a shell of amorphous cupric oxide (CuO) present on at least a portion of the surface of the core.

In specific embodiments of the disclosed subject matter, the copper oxide nanoparticle has the structure Cu₂O—CuO.

In specific embodiments of the disclosed subject matter, the copper oxide nanoparticle is a Cu(I)/Cu(II) oxide nanoparticle.

In specific embodiments of the disclosed subject matter, the core includes crystalline copper-cuprous oxide (Cu^{o}—Cu₂O).

In specific embodiments of the disclosed subject matter, the cupric oxide (CuO) can have a thickness of up to about 1 nm.

In specific embodiments of the disclosed subject matter, the copper oxide nanoparticle can have a diameter of about 2-40 nm. In further specific embodiments of the disclosed subject matter, the copper oxide nanoparticle can have a diameter of about 4-25 nm. In yet further specific embodiments of the disclosed subject matter, the copper oxide nanoparticle can have a diameter of about 4-12 nm.

In specific embodiments of the disclosed subject matter, the copper oxide nanoparticle can be present as multiple copper oxide nanoparticles. In further specific embodiments of the disclosed subject matter, the copper oxide nanoparticles can be monodisperse, such that the root mean square deviation from the diameter is less than 10%. In yet further specific embodiments of the disclosed subject matter, the copper oxide nanopaiticles can be highly monodisperse, such that the root mean square deviation from the diameter is less than 5%.

In specific embodiments of the disclosed subject matter, a surfactant can be bound to at least a portion of the surface of the copper oxide nanoparticle. In further specific embodiments of the disclosed subject matter, a monolayer of surfactant can be bound to at least a portion of the surface of the copper oxide nanopaiticle. In yet further specific embodiments of the disclosed subject matter, a surfactant can be bound to at least a portion of the surface of the copper oxide nanoparticle, wherein the surfactant includes a compound of the formula

R¹C(═X)Y

wherein,
R¹ is (C₁₀-C₃₀) alkyl, substituted (C₁₀-C₃₀) alkyl (C₁₀-C₃₀) alkenyl, substituted (C₁₀-C₃₀) alkenyl, (C₁₀-C₃₀) cycloalkyl, or substituted (C₁₀-C₃₀) cycloalkyl;
X is O, S or NOH; and
Y is OH, O-(C₁₀-C₃₀) alkyl, substituted O-(C₁₀-C₃₀) alkyl, O-(C₁₀-C₃₀) alkenyl or substituted O-(C₁₀-C₃₀) alkenyl,
or a suitable salt thereof.

In yet further specific embodiments of the disclosed subject matter, a surfactant can be bound to at least a portion of the surface of the copper oxide nanoparticle, wherein the surfactant includes oleic acid, lauric acid, octanoic acid, stearic acid, 1-octadecanol, elaidic acid, 2-acetyl pyridine, p-anisaldehyde, butyrolactone, 1-formyl piperidine, ethylene carbonate, propylene carbonate, gamma-buytrolactone, catechols, benzylamine oleylamine, or a combination thereof. Specifically, the surfactant can include oleic acid.

The copper oxide-nanoparticle is dispersed or supported upon the surface of a spacer. In specific embodirments of the disclosed subject matter, the spacer includes silica gel, alumina, zeolite, or a combination thereof. In further specific embodiments of the disclosed subject matter, the spacer includes silica gel. In yet further specific embodiments of the disclosed subject matter, the spacer includes silica gel having a surface area of about 500 m²/g to about 600 m²/g.

### Catalyst

The catalyst of the disclosed subject matter includes: (a) a copper oxide nanopaiticle that includes: (i) a core that includes copper-cuprous oxide (Cu^{o}—Cu₂O); and (ii) cupric oxide (CuO) present on at least a portion of the surface of the core; (b) optionally a surfactant present on at least a portion of the surface of the copper oxide nanoparticle; and (c) a spacer in which the copper oxide nanoparticle is dispersed or supported upon the surface thereof.

In specific embodiments of the disclosed subject matter, the copper oxide nanoparticle has a surface to volume ratio of at least about 250 to about 1500.

In specific embodiments of the disclosed subject matter, the copper oxide nanoparticle has the structure Cu^{o}—Cu₂O—CuO.

In specific embodiments of the disclosed subject matter, the copper oxide nanoparticle is a Cu/Cu(I)/Cu(II) oxide nanoparticle.

In specific embodiments of the disclosed subject matter, the surfactant is absent. Alternatively, in other specific embodiments of the disclosed subject matter, the surfactant is present. Additionally, in further specific embodiments of the disclosed subject matter, the surfactant is present, and is bound to at least a portion of the surface of the copper oxide nanoparticle.

In specific embodiments of the disclosed subject matter, the catalyst has a surface area of about 300 m²/g to about 350 m²/g.

In specific embodiments of the disclosed subject matter, the catalyst has a pore size of about 280 m²/g to about 600 m²/g. In further specific embodiments of the disclosed subject matter, the catalyst has a pore size of about 300 m²/g to about 350 m²/g.

In specific embodiments of the disclosed subject matter, the catalyst further includes at least one additional co-catalyst. In further specific embodiments of the disclosed subject matter, the catalyst further includes at least one additional co-catalyst including a metal selected from the group of copper (Cu), chromium (Cr), nickel (Ni), cobalt (Co), iron (Fe), manganese (Mn), platinum (Pt), palladium (Pd), rhodium (Rh), iridium (Ir) and gold (Au). In yet further specific embodiments of the disclosed subject matter, the catalyst further includes at least one additional co-catalyst including a metal selected from the group of platinum (Pt), palladium (Pd), rhodium (Rh), iridium (Ir) and gold (Au). In yet further specific embodiments of the disclosed subject matter, the catalyst further includes at least one additional co-catalyst selected from the group of CuO, Cu₂O, Mn₃O₄ and CeO₂. In yet furtlher specific embodiments of the disclosed subject matter, the catalyst further includes CeO₂ as a co-catalyst. In yet further specific embodiments of the disclosed subject matter, the catalyst further includes up to about 20 wt. % CeO₂ as a co-catalyst. In yet further specific embodiments of the disclosed subject matter, the catalyst further includes about 4 wt. % to about 15 wt. % CeO₂ as a co-catalyst. In yet further specific embodiments of the disclosed subject matter, the co-catalyst is a nanoparticle.

Methods of using the Catalyst to Oxidize Carbon Monoxide to Carbon Dioxide

The disclosed subject matter includes a method for oxidizing carbon monoxide (CO) to carbon dioxide (CO₂), that includes contacting the catalyst of the disclosed subject matter, and a gaseous mixture that includes carbon monoxide (CO) and oxygen (O₂).

In specific embodiments of the disclosed subject matter, the gaseous mixture includes carbon monoxide (CO) and oxygen (O₂), in a ratio of at least about 2:1. In further specific embodiments of the disclosed subject matter, the gaseous mixture includes carbon monoxide (CO) and oxygen (O₂), in a ratio of 2:1 to about 2:10. In yet further specific embodiments of the disclosed subject matter, the gaseous mixture includes carbon monoxide (CO) and oxygen (O₂), in a ratio of 2:1 to about 2:5. In yet further specific embodiments of the disclosed subject matter, the gaseous mixture includes carbon monoxide (CO) and oxygen (O₂), in a ratio of 2:1 to about 1:1.

In specific embodiments of the disclosed subject matter, the gaseous mixture further includes hydrogen (H₂). In other specific embodiments of the disclosed subject matter, the gaseous mixture further includes one or more inert gases. In other specific embodiments of the disclosed subject matter, the gaseous mixture further includes nitrogen (N₂).

In specific embodiments of the disclosed subject matter, at least about 99 (v) % of the carbon monoxide (CO) is oxidized to carbon dioxide (CO₂), at a period of time greater than about 12 hours. In further specific embodiments of the disclosed subject matter, at least about 90 (v) % of the carbon monoxide (CO) is oxidized to carbon dioxide (CO₂), at a period of time greater than about 120 hours. In yet further specific embodiments of the disclosed subject matter, at least about 99.5 (v) % of the carbon monoxide (CO) is oxidized to carbon dioxide (CO₂) at a period of time greater than about 120 hours. In other specific embodiments of the disclosed subject matter, carbon monoxide (CO) is oxidized to carbon dioxide (CO₂), at a period of time of up to about 220 hours.

In specific embodiments of the disclosed subject matter, the method for oxidizing carbon monoxide (CO) to carbon dioxide (CO₂) is carried out at a temperature of about 120° C. to about 280° C. In other specific embodiments of the disclosed subject matter, the flow rate of the gaseous mixture corresponds to a space velocity of at least about 80,000 hr⁻¹. In further specific embodiments of the disclosed subject matter, the flow rate of the gaseous mixture corresponds to a space velocity of up to about 200,000 hr⁻¹.

Methods of using the Catalyst to Catalyze Chemical Reactions

The disclosed subject matter includes a method for catalyzing a chemical reaction, the method includes contacting starting material of the chemical reaction with a catalyst of the disclosed subject matter, under suitable conditions effective to catalyze the reaction.

In specific embodiments of the disclosed subject matter, the reaction includes oxidizing carbon monoxide (CO) to carbon dioxide (CO₂). In other specific embodiments of the disclosed subject matter, the reaction includes reducing NOₓ, wherein x is 1 or 2. In other specific embodiments of the disclosed subject matter, the reaction includes reducing SO₂. In other specific embodiments of the disclosed subject matter, the reaction includes oxidizing a hydrocarbon. In other specific embodiments of the disclosed subject matter, the reaction includes coupling two or more aryl halides (Ullmann coupling). In further specific embodiments of the disclosed subject matter, the reaction includes coupling two or more aryl halides (Ullmann coupling), wherein each of the aryl halides are the same. In alternate specific embodiments of the disclosed subject matter, the reaction includes coupling two or more aryl halides (Ullmann coupling), wherein each of the aryl halides are different.

In specific embodiments of the disclosed subject matter, the starting material includes carbon monoxide (CO), nitric acid (NO₃), nitrogen dioxide (NO₂), nitric oxide (NO), sulfur dioxide (SO₂), a hydrocarbon, or two or more aryl halides.

In specific embodiments of the disclosed subject matter, the chemical reaction occurs at a temperature of less than about 400° C. In further specific embodiments of the disclosed subject matter, the chemical reaction occurs at a temperature of less than about 300° C. In yet further specific embodiments of the disclosed subject matter, the chemical reaction occurs at a temperature of less than about 250° C.

### Methods of Manufacturing (Processing)

In the methods of manufacturing described herein, the steps can be carried out in any order without departing from the principles of the disclosed subject matter, except when a temporal or operational sequence is explicitly recited. Recitation in a claim to the effect that first a step is performed, then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

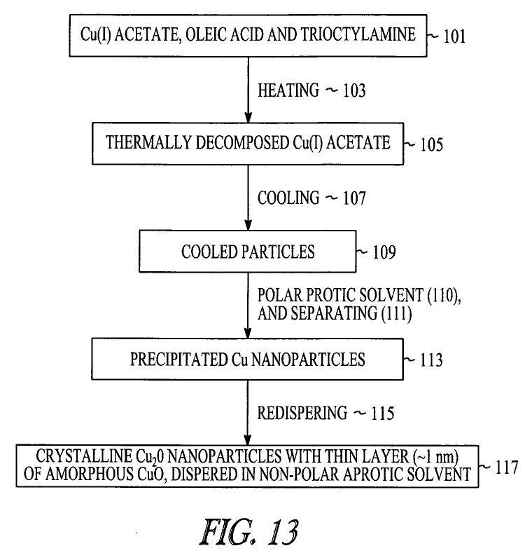

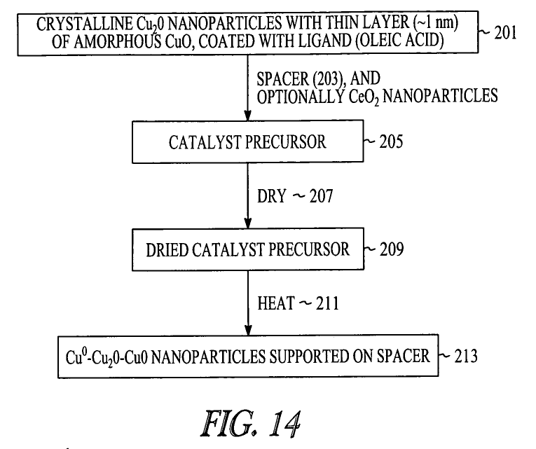

Referring to FIGS. 13-14, methods to manufacture nanoparticles, nanoparticle systems and/or catalysts of the disclosed subject matter are provided.

Briefly stated, FIG. 14 illustrates a method to manufacture copper oxide nanoparticles (117) of the disclosed subject matter. The method includes heating (103) a mixture of copper (I) acetate, oleic acid and trioctylamine (101), to provide thermally decomposed copper (I) acetate (105). The thermally decomposed copper (I) acetate (105) is cooled (107), to provide cooled particles (109). The cooled particles (109) are contacted with a polar protic solvent (110), and separated (111), to provide precipitated copper oxide nanopaiticles (113). The precipitated copper oxide nanoparticles (113) are redispersed (115), to provide the copper oxide nanoparticles (117).

The copper oxide nanoparticles (117) of the disclosed subject matter are crystalline cuprous oxide (Cu₂O) nanioparticles, with a thin layer (e.g., about 1 nm) of amorphous cupric oxide (CuO). Specifically, the inorganic core is composed of a highly crystalline cuprous oxide (Cu₂O) and a thin (<5 Å) shell of amorphous cupric oxide (CuO) exists about the core. As such, the copper oxide nanoparticles (117) are stabilized in the +1 oxidation state. The copper oxide nanoparticles (117) are optionally dispersed in a non-polar solvent (e.g., hexane).

The heating (103) can be carried out at any suitable temperature, and for any suitable period of time, provided the heating (103) effectively provides thermally decomposed copper (I) acetate (105). For example, the heating (103) can be carried out at a temperature of up to about 320° C., up to about 300° C., or up to about 280° C. Specifically, the heating (103) can be carried out at a temperature of about 240° C. to about 320° C., about 250° C. to about 300° C., or about 260° C. to about 280° C. Additionally, the heating (103) can be carried out for a period of time of up to about 5 hours. Specifically, the heating (103) can be carried out for a period of time of about 10 minutes to about 5 hours, about 20 minutes to about 3 hours, or about 45 minutes to about 2 hours.

The cooling (107) can be carried out at any suitable temperature, and for any suitable period of time, provided the cooling (107) effectively provides cooled particles (109). For example, the cooling (107) can be carried out at a temperature of less than about 50° C., less than about 40° C., or less than about 25° C. Specifically, the cooling (107) can be carried out at a temperature of about 0° C. to about 50° C., about 10° C. to about 40° C., or about 15° C. to about 30° C. Additionally, the cooling (107) can be carried out for a period of time of up to about 5 hours. Specifically, the cooling (107) can be carried out for a period of time of about 10 minutes to about 8 hours, about 20 minutes to about 5 hours, or about 1 hour to about 4 hours. In one specific embodiment, the thermally decomposed copper (I) acetate (105) can be cooled to room temperature.

As stated above, the cooled particles (109) are contacted with a polar protic solvent (110) and separated (111), to provide precipitated copper oxide nanoparticles (113). Any suitable polar protic solvent (110) can be employed, e.g., one or more alcohols such as ethanol (neat).

The separation (111) can be carried out employing any suitable technique, provided the precipitated copper oxide naiiopaiticles (113) are effectively obtained. Suitable techniques include, e.g., filtration, decantation, or a combination thereof.

As stated above, the precipitated copper oxide nanoparticles (113) are redispersed (115), to provide the copper oxide nanoparticles (117). The redispersing (115) can employ any suitable solvent, provided the copper oxide nanoparticles (117) are effectively obtained. For example, the solvent can be a non-polar aprotic solvent such as hexanes.

In one embodiment, the copper oxide nanoparticles (117) can be coated with a ligand shell of, e.g., oleic acid. The coating can be a single monolayer of ligand (e.g., oleic acid) molecules bound to the surface of the copper oxide nanoparticles (117). The binding can be electrostatic, covalent, chemisorbed or physisorbed in nature.

The copper oxide nanoparticles (117) obtained from the procedures described herein are typically stable in non-polar solvents (e.g., hexane) and typically have non-polar capping groups. The capping groups, also called ligands because they bind to the surface of the nanocrystal, are typically long-chain alkyl surfactants with heteroatom or polar head groups that react with and/or bind to the nanocrystal surface via covalent, electrostatic or coordination bonds (or some combination of all three), generally to the metal atoms. The lability of the surface ligand (i.e., ease with which it can be exchanged) typically depends upon the strength of the binding interaction.

The ligand shell is preferred for catalyst preparation because it allows for homogeneous mixing of the monodisperse catalyst nanoparticles with the catalyst support, prior to the catalytic oxidation reaction. This enables distribution of the copper oxide nanoparticles over the support, and minimizes or diminishes the occurrence of sintering of the catalyst duiing the catalytic oxidation reaction, which is believed why the catalyst has relatively extremely long lifetimes.

Without being bound to any particular theory, it is believed that the copper oxide nanoparticles (117) remain highly stabilized in solution, because they have a surface that is mutually unreactive and repulsive towards other particles. This can be considered as steric stabilization. Steric stabilization originates in cntropic effects which can be understood in terms of the required reorganization of the surfactant coating around the nanocrystal if they are to be packed tighter. Decreasing the distance between nanopaiticles would force the stabilizing surfactants into a smaller and more restricted space—a process that would decrease the entropy of the system, and violate steric interactions. Decrease of the entropy renders a close approach of the nanoparticles to be thermodynamically unfavorable in solution. During the solvent evaporation process phase, separation can readily occur and promote assembly of the nanocrystals into ordered regions and ultimately self-assembled superlattices. Reversible flocculation can be caused with the addition of polar solvents to precipitate them out of solution, but they can just as readily be re-dissolved again in a non-polar solvents, provided the capping group remains intact.

Briefly stated, FIG. 14 illustrates a method to manufacture a catalyst of the disclosed subject matter, which is a Cu⁰—Cu₂O—CuO nanoparticle supported on a spacer (213). The method includes contacting a spacer with a nanoparticle (201) described herein (e.g., crystalline cuprous oxide (Cu₂O) nanoparticles, with a thin layer (e.g., about 1 nm) of amorphous cupric oxide (CuO)), that is coated with a ligand, to provide a catalyst precursor (205). The catalyst precursor (205) is dried (207) to provide a dried catalyst precursor (209), which is heated (211) to provide the catalyst (213). The nanoparticle (201) is contacted with a spacer (203), effective to provide a catalyst precursor (205). Any suitable spacer (203) can be employed, provided the catalyst precursor (205) is effectively obtained. Suitable spacers include, e.g., silica gel, mesoporous silica, alumina, zeolite, ceria/ceria oxide, fumed silica, characterized silica, and combinations thereof. Specifically, the spacer (203) can be silica gel, having a surface area of about 500 m²/g to about 600 m²/g.

The active catalyst is believed to be a Cu⁰/Cu(I)/Cu(II) oxide system. Reversible oxidation and reduction is typically required for catalyst activity. As such, the copper is relatively sensitive to the oxidation state of the catalyst prior to and during catalytic oxidation.

One or more suitable co-catalysts can be employed (i.e., further included) in the catalysts (213) of the disclosed subject matter. When employed, such co-catalysts can be introduced in the manufacturing processes described herein in any suitable step, and in any suitable manner, provided the catalysts (213) of the disclosed subject matter are effectively obtained. For example, cerium(IV) oxide (CeO₂) nanoparticles can be employed as a co-catalyst. Additionally, the cerium(IV) oxide (CeO₂) nanoparticles, in addition to the spacer (203), can be contacted with the nanoparticles (201). More specifically, nanoparticles (201) are contacted with a combination of cerium(IV) oxide (CeO₂) nanoparticles and silica gel having a surface area of about 500 m²/g to about 600 m²/g, to effectively provide a catalyst precursor (205).

The catalyst precursor (205) is effectively dried (207), to provide dried catalyst precursor (209). The drying (207) can occur under any suitable conditions (e.g., time, temperature and pressure), effective to provide dried catalyst precursor (209). For example, the drying (207) can occur at room temperature with atmospheric air or with an inert gas.

Prior to the heating (211), the copper oxide nanoparticle, in the form of the dried catalyst precursor (209) is uniquely stabilized in the Cu(I) form. This contributes to the performance of the catalyst (213).

The dried catalyst precursor (209) is heated (211), to provide the catalyst (213). The heating (211) can be carried out in any suitable manner, provided the catalyst (213) is effectively obtained. The heating (211) can be carried out at any suitable temperature, and for any suitable period of time, provided the heating (211) effectively provides catalyst (213). For example, the heating (211) can be carried out at a temperature of up to about 320° C., up to about 275° C., or up to about 250° C. Specifically, the heating (211) can be carried out at a temperature of about 200° C. to about 320° C., about 210° C. to about 300° C., or about 220° C. to about 260° C. Additionally, the heating (211) can be carried out for a period of time of up to about 5 hours. Specifically, the heating (211) can be carried out for a period of time of about IO minutes to about 5 hours, about 20 minutes to about 3 hours, or about 45 minutes to about 2 hours. Additionally, the heating (211) can be carried out under one or more inert gases (e.g., nitrogen).

The disclosed subject matter includes a method for manufacturing a catalyst, the method includes: (a) contacting a spacer with a nanoparticle, the nanoparticle includes: (i) a copper oxide nanoparticle that includes: (A) a core that includes crystalline cuprous oxide (Cu₂O); and (B) a shell of amorphous cupric oxide (CuO) present on at least a portion of the surface of the core; and (ii) a ligand which coats the copper oxide nanoparticle; to form a catalyst precursor; (b) drying the catalyst precursor to provide a dried catalyst precursor; and (c) heating the dried catalyst precursor, effective to remove the ligand.

In specific embodiments of the disclosed subject matter, the spacer includes silica gel, alumina, zeolite, or a combination thereof. In further specific embodiments of the disclosed subject matter, the spacer includes silica gel having a surface area of about 500 m²/g to about 600 m²/g.

In specific embodiments of the disclosed subject matter, the contacting of the spacer with the nanoparticle further includes contacting the nanoparticle with CeO₂ nanoparticles.

In specific embodiments of the disclosed subject matter, the contacting of the spacer with the nanoparticle occurs at room temperature.

In specific embodiments of the disclosed subject matter, the contacting of the spacer with the nanoparticle occurs while agitating.

In specific embodiments of the disclosed subject matter, the drying of the catalyst precursor to provide a dried catalyst precursor occurs under atmospheric air.

In specific embodiments of the disclosed subject matter, the drying of the catalyst precursor to provide a dried catalyst precursor occurs under one or more inert gases.

In specific embodiments of the disclosed subject matter, the heating the dried catalyst precursor, effective to remove the ligand, occurs at a temperature of about 225° C. to about 275° C.

In specific embodiments of the disclosed subject matter, the heating the dried catalyst precursor, effective to remove the ligand, occurs in the presence of one or more inert gases.

In specific embodiments of the disclosed subject matter, the heating the dried catalyst precursor, effective to remove the ligand, occurs in the presence of nitrogen (N₂), argon (Ar), or a combination thereof.

In specific embodiments of the disclosed subject matter, the nanoparticle can be prepared by the method that includes: (d) contacting copper acetate, oleic acid and trioctylamine; and heating to provide thermally decomposed copper acetate; (e) cooling the thermally decomposed the copper acetate to provide cooled particles; (f) contacting the cooled particles with a solvent, and separating to provide precipitated copper oxide nanoparticles; and (g) redispersing the precipitated copper oxide nanoparticles.

In further specific embodiments of the disclosed subject matter, the heating to provide the thermally decomposed copper acetate occurs at a temperature of about 200° C. to about 300° C. In yet further specific embodiments of the disclosed subject matter, the heating to provide the thermally decomposed copper acetate occurs at a temperature of about 220° C. to about 250° C.

In further specific embodiments of the disclosed subject matter, the heating to provide the thermally decomposed copper acetate occurs in the presence of one or more inert gases. In yet further specific embodiments of the disclosed subject matter, the heating to provide the thermally decomposed copper acetate occurs in the presence of nitrogen (N₂), argon (Ar), or a combination thereof.

In further specific embodiments of the disclosed subject matter, the heating to provide the thermally decomposed copper acetate occurs for at least about 30 min. In other specific embodiments of the disclosed subject matter, the heating to provide the thermally decomposed copper acetate occurs at about room temperature.

In further specific embodiments of the disclosed subject matter, the solvent in (f) includes at least one polar protic organic solvent. In yet further specific embodiments of the disclosed subject matter, the solvent in (f) includes at least one alcohol. In yet further specific embodiments of the disclosed subject matter, the solvent in (f) includes ethanol (neat).

In further specific embodiments of the disclosed subject matter, the separating to provide precipitated copper oxide nanoparticles includes centrifuging.

In further specific embodiments of the disclosed subject matter, the redispersing in (g) occurs in the presence of a second solvent that includes at least one non-polar aprotic organic solvent. In yet further specific embodiments of the disclosed subject matter, the redispersing in (g) occurs in the presence of a second solvent that includes hexanes.

The disclosed subject matter can be illustrated by the following non-limiting examples.

### EXAMPLES

### Example 1

### Preparation of Nanoparticles

Cuprous oxide (Cu₂O) nanoparticles were synthesized using a previously published procedure (Yin, M.; Wu, C. K.; Lou, Y.; Burda, C.; Koberstein, J. T.; Zhu, Y.; O'Brien, S. J Am Chem Soc 2005, 127, 9506-11; and Published PCT Patent Application WO/2005/060610, published on Jul. 7, 2005), where 4 mmol Cu (I) acetate, 4 mL technical grade (90%) oleic acid, and 15 mL trioctylamine were placed in a European style four-neck flask with a stir bar and heated to 180° C. to remove any low boiling point impurities and then allowed to thermally decompose under argon at 270° C. for 1 hour. The particles were then cooled to room temperature, precipitated bv adding 40 mL of pure ethanol and centrifuiging at 2000×g, and redispersed in approximately 30 mL of hexanes. In the hexanes, the deep red Cu nanoparticles oxidized to dark green cuprous oxide (Cu₂O) nanoparticles with a thin layer (˜0.5-1 nm) of CuO (Yin, M.; Wu, C. K.; Lou, Y.; Burda, C.; Koberstein, J. T.; Zhu. Y.; O'Brien, S. J Am Chem Soc 2005, 127, 9506-11) over the next few hours. Transmission electron micrographs (TEM) show the nanoparticles can vary from 4-25 nm in diameter, but within a sample are relatively monodisperse (<10% rms). X-ray diffraction (XRD) reveals the nanoparticles to be crystalline cuprous oxide (Cu₂O).

### Example 2

### Flow Reactor

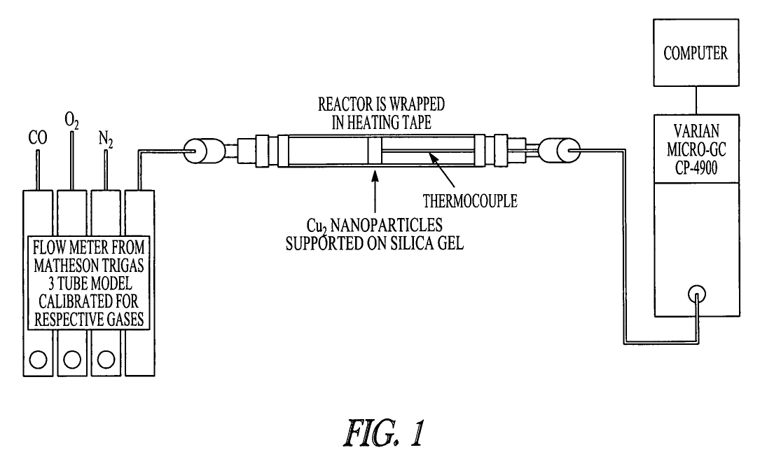

The continuous flow reactor (FIG. 1) consists of a medium porosity glass frit in the middle of a 18 cm long, 20 mm I.D. glass tube connected to a 3-tube gas mixer from Matheson Tri-Gas, which controls the flow and concentration of the gases. Analysis of the exhaust is carried out by a Varian CP-4900 Micro-GC. The μGC contains 2 columns, a 10 m PoraPlot U (PPU) to detect N₂, O₂, and CO and a 10 m MolSieve 5 Å (MS5 Å) to detect CO₂, with a detection limit of 1 ppm for all gases employing the micro-machined thermal conductivity detector. Heating tape wrapped around the flow reactor and powered by a rheostat keeps the temperature constant to within a degree Celsius over several hours. The temperature is monitored downstream of the glass frit by a type T thermocouple sheathed in glass braided insulation. CO oxidation was carried out using the continuous flow reactor operating at 240° C. with a total gas flow of 260 mL/min.

### Example 3

### Sample Preparation

In a typical experiment, 1.0 mL of 0.03 M Cu₂O nanoparticles were mixed with 75 mg of silica (Sorbent Technologies, 32-63 μm diameter with 6 nm pores—Standard Grade), placed on the glass frit, and dried under air. Once dry, the flow reactor was assembled and heated to 240° C. for one hour under N₂ at 240 mL/min. After the heat-up period, 4% CO and 3% O₂, with a balance of N₂ were introduced into the system, with a total flow of 260 mL/min. Samples of the exhaust were taken approximately every 10 minutes and analyzed for relative concentrations of CO, N₂, O₂, and CO₂.

Gas hourly space velocity (GHSV) is a measure of the flow of gas over the catalyst in a given time period:

$$GHSV = \frac{{V}_{gas}}{{V}_{catalyst}}$$

Wherein, V_{gas} is the volume of gas that flows over the catalyst in one hour and V_{catalyst} is the volume of the total catalyst (support and metal), both values are in the same volume units, usually milliliters. The catalyst system studied here had a GHSV of ˜80,000 h⁻¹, and depending on the potential application is more than sufficient. Watanabe, M.; Uchida, H.; Ohkubo, K.; Igarashi, H. Appl. Catal., B 2003. 46, 595-600; Larsson, P.-O.; Andersson, A. Journal of Catalysis 1998, 179, 72-89; and Tang, X.; Zhang, B.; Li, Y.; Xu, Y.; Xin, Q.; Shen, W. Catalysis Today 2004, 93-95, 191-198. The higher the GHSV, the more gas can be reacted per unit time, making the process more efficient and saving time and costs.

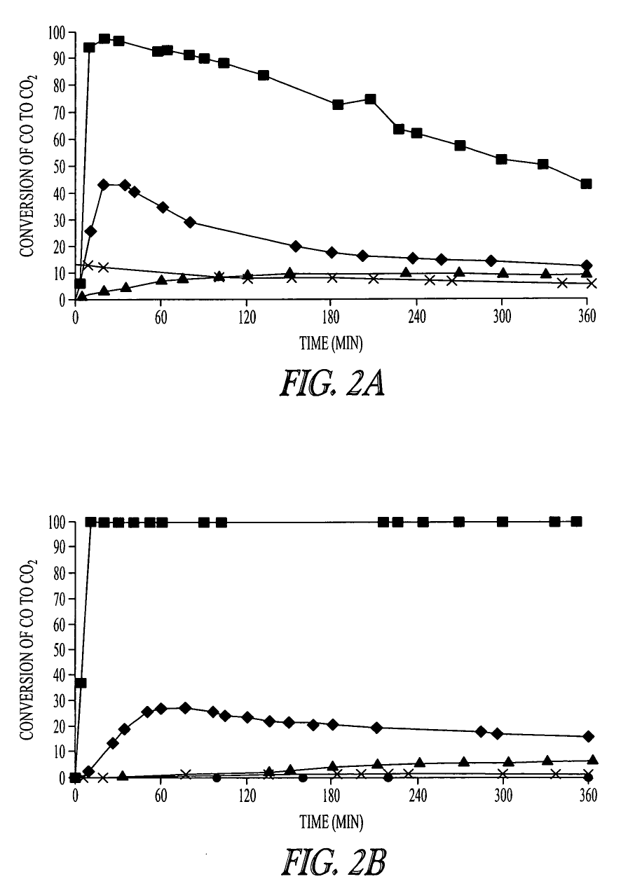

Control experiments were performed to demonstrate the exceptional performance of ouI supported Cu₂O nanoparticles. Samples of Cu, Cu₂O, and CuO powders (Aldrich, used as received) were all tested for conversion both alone and in the presence of silica gel at similar loadings to the experiments with Cu₂O nanoparticles. None of the bulk powders loaded with silica gel showed any significant catalytic activity (FIG. 2).

### Example 4

### Activity Measurement

All samples were run in the continuous flow reactor for a minimum of 360 minutes and analyzed on stream by the μGC. The conversion percentage of CO to CO₂ was calculated from the resulting integrated peak areas by:

$$Conversion \% = \frac{{A}_{{CO}_{2}}}{{A}_{{CO}_{2}} + {A}_{CO}} ⋆ 100 \%$$

where and A_{CO} are the integrated peak areas of the CO₂ and CO being detected, respectively. The resulting conversion of CO was then plotted as a function of time (FIG. 2).

### Example 5

### Sample Analysis

Catalyst loading was an important factor in the activity of the nanoparticle system, and therefore accurate values of the concentration of nanoparticle dispersions were needed. In addition to the elemental analysis and TGA, gravimetric analysis was used to find the concentration of particles (metal and ligand) in a given sample and TEM was used to determine the average particle size, which was relatively monodisperse (<10% rms diameter). Because of the uniformity in diameters, accurate percent weight concentrations were estimated and replicated using spectrophotometric calculations of concentration based on the absorption coefficient of the dispersion. Assuming a 5 Å thick layer of CuO on the particle (as estimated from XPS measurements, Yin, M.; Wu, C. K.; Lou, Y.; Burda, C.; Koberstein, J. T.; Zhu, Y.; O'Brien, S. J Am Chem Soc 2005, 127, 9506-11), the molecular weight was calculated using the weighted average of CuO and Cu₂O and a spherical model. The concentration of our samples ranged from 0.02 to 0.04 M, which results in an absorption coefficient, ε, at 340 nm of 2300±600 L*mol⁻¹*cm⁻¹.

To obtain a catalytic system, nanoparticle dispersions in hexanes were mixed with silica gel (SA˜500-600 m²/g), stirred at room temperature, and transferred to the reactor. The nanoparticle ligand, oleic acid, both stabilized the nanoparticles and minimized or diminished the occurrence of aggregation in solutions and in films, which is important to the catalyst preparation prior to its use. A wide-range of nanopaiticle loadings were tested on silica gel. Without being bound to any particular theory, it is hypothesized that silica gel separates the nanoparticles, thus minimizing or diminishing the occurrence of sintering, and therefore maximizing the surface area available for oxidation. Without the silica gel as a spacer, the nanoparticles would pack together and most likely sinter, thus decreasing the effective surface area and the rate of CO oxidation (FIG. 2).

In addition to studying the nanoparticles, bulk samples of all of copper's oxidation states in the form of powders were studied (FIG. 2). Compared to the Cu₂O nanoparticles, none of the powders performed well, most likely due to the low sample loading. Cu⁰ powder performed the best among the powders in the presence and absence of silica gel, different than previously reported. Tsai et al. (Huang, T.-J.; Tsai, D.-H. Catal. Lett. 2003, 87, 173-178) show that under oxygen rich and poor conditions Cu₂O powder performs better than Cu and CuO due to its ability to readily accept and donate oxygen and change its oxidation state. The volume of powders employed here was probably too small, and therefore the GHSV was too high for the catalyst to be active.

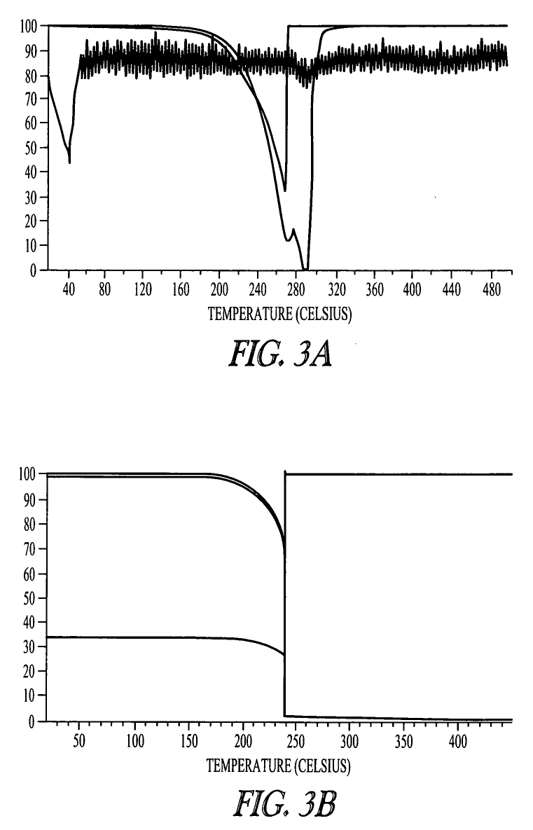

To gain better insight into the Cu₂O nanoparticle based catalyst, thermogravimetric analysis and X-rav powder diffraction (XRD) experiments were used to determine the composition and oxidation state, respectively, of the as synthesized and post-reaction catalyst materials. The thermogram (FIG. 3) of Cu₂O nanoparticles shows they are coated with oleic acid after synthesis. Oleic acid decomposes at the same temperature as a major species decomposes from the Cu₂O nanoparticles at ˜290° C. (FIG. 3A). The bimodal distribution of the oleic acid mass derivative is believed to be due to impurities in the technical grade oleic acid that was used. It is from this that oleic acid is assumed to be the only species present on the surface of the nanoparticles. By simulating the temperature profile of the reaction in the TGA, we can determine the absence of oleic acid at the beginning of the CO oxidation reaction. From the differential of the mass curve in FIG. 3B, where the temperature is ramped to 240° C. and held constant for 30 minutes, it can be seen that the oleic acid is completely decomposed at this temperature. Repeating this experiment with the nanoparticles coated in oleic acid exhibits similar weight loss behavior. This TGA data suggests that the Cu₂O nanopaiticles are completely bare at the end of the pretreatment, prior to CO oxidation. The low signal to noise ratio for the nanoparticle sample is attributed to small sample size and a small amount of ligand present on the surface.

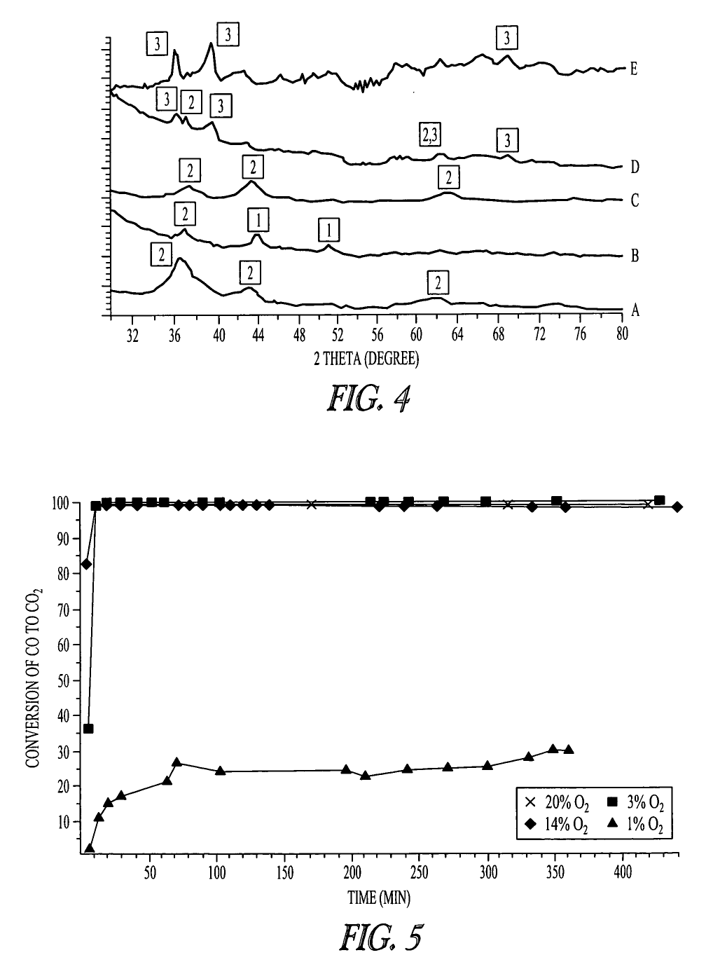

XRD was then used to follow the oxidation state of the Cu₂O nanoparticles throughout the catalytic reaction. To begin, the crystalline Cu₂O nanoparticles (FIG. 4A) on silica are pretreated at 240° C. for one hour under N₂, during which the exposed surface is partially reduced to Cu⁰ (FIG. 4B). Upon introduction of CO and O₂ into the system, there is low conversion for approximately 10-20 minutes, during which the nanoparticles are oxidized to the Cu⁺ state (FIG. 4C). Oxidizing the sample in O₂ for 20 minutes prior to adding the CO reduces the induction period to less than four minutes. As the reaction continues and the conversion of CO decreases, more CuO character appears in nanoparticles (FIG. 4D, E).

### Example 6

### Catalytic Activity

Oxygen concentration is a very important factor in the oxidation process of carbon monoxide to carbon dioxide. Much of the CO oxidation work found in the literature (Chiang, C. W.; Wang, A.; Wan, B. Z.; Mou, C. Y. J. Phys. Chem. B 2005, 109, 18042-18047 and Skarman, B.; Grandjean, D.; Benfield, R. E.; Hinz, A.; Andersson, A.; Wallenberg, L. R. J. Catal 2002, 211, 119-133) uses 1-2% CO and 19% O₂ in an inert gas. This ensures there is enough oxygen for the reaction and keeps the catalyst fully oxidized. We found that high concentrations of O₂ work just as well as stoichiometric ratios of CO:O₂ (FIG. 5). The conversion is independent of O₂ concentration, 2:1 ratios of CO—O₂ as well as 1:5 ratios of CO—O₂ result in a high percent of CO oxidation. The lowest useable oxygen concentration is about a 2:1 ratio of CO to O₂, where all of the O₂ is used up in the conversion of CO to CO₂. Over the short time period of seven hours, as long as enough oxygen was supplied to the surface of the copper oxide, the excess O₂ did not pose a detrimental problem to the catalyst, although longer tests should be carried out.

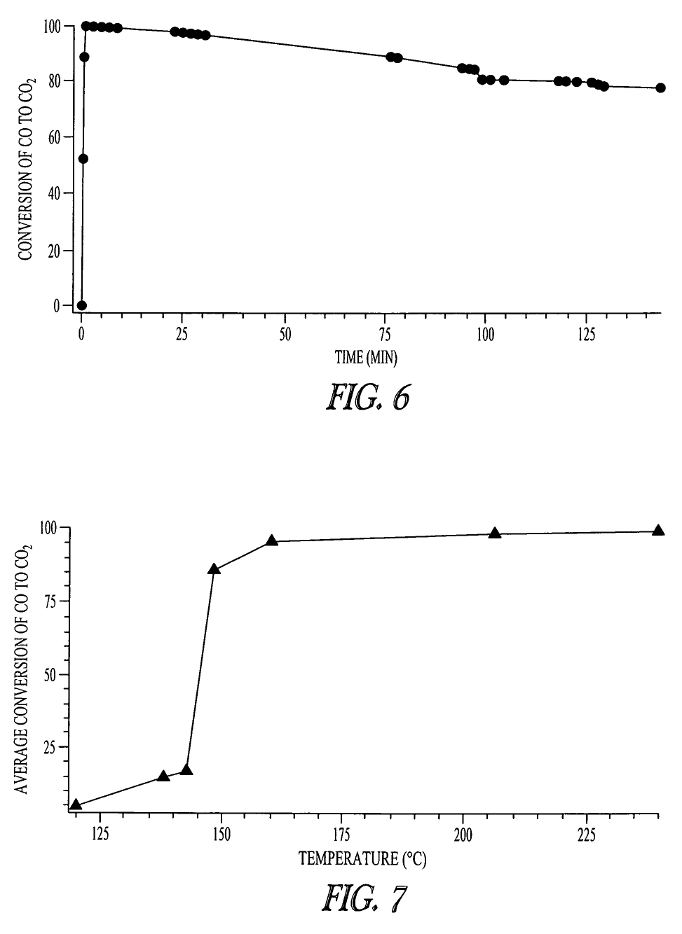

Most of the studies conducted on the Cu₂O catalyst system were carried out for six hours, over which various trends were observed. To be as commercially viable of a product, the catalyst will last for a longer timeframe as reasonably possible. It was found that conversion remains above 99.5% for over 12 hours, after which it begins to gradually decline. The catalyst was tested for extended periods under continuous CO/O₂ flow and over 144 hours the conversion dropped from 99.9% to 85% (FIG. 6). Twelve hours may be enough for a single use or short timeframe catalyst, but increasing the lifetime would greatly improve the number of potential uses other than oxidizing carbon monoxide to carbon dioxide.

Light-off temperature is a measure of how active the catalyst is, as a function of temperature, and is expressed as T₅₀, or the temperature at which the catalyst operates at 50% efficiency. To find the activity of the Cu₂O nanoparticles at various temperatures the samples were first pretreated in N₂ at 240° C. for one hour and then treated in an O₂ environment (3% O₂ and 97% N₂) for 20 minutes to reoxidize the sample before lowering the applied heat to the rim temperature. Conversion was monitored for 120 minutes and averaged to determine the conversion at a given temperature (FIG. 7). The steep slope of the curve is indicative of the presence of mostly active sites, in agreement with the high surface area nanoparticles. We found that the T₅₀ to be approximately 145° C. Above 160° C., the average conversion is greater than 95%. Depending on the desired level of CO removal, the catalyst can operate well below 200° C.

### Example 7

### Theoretical Calculations

With such high catalytic activity, a deeper look into the mechanism was initiated. Studies of the mechanism of CO oxidation on copper oxides in the bulk have been complicated by many subtleties. Jernigan, G. G.; Somorjai, G. A. J. Catal. 1994, 147, 567-77. But it is generally assumed that CO oxidation on metal surfaces proceeds via a Langmuir-Hinshelwood mechanism, where carbon monoxide and oxygen are adsorbed on the surface on the copper oxide lattice and react to form CO₂. Oxygen vacancies are replenished through the adsorption and dissociation of gas phase oxygen. Presumably a similar process occurs for the nanoparticles but with an unexpected high level of efficiency. In our reaction, the used catalyst shows evidence of CuO as well as Cu₂O (FIG. 4D, E), suggesting a mixed state of Cu⁺ and Cu²⁺, most likely a redox reaction between the two states (FIG. 8). This observation is consistent with previous reports for the bulk (Huang, T.-J.; Tsai, D.-H. Catal. Lett. 2003, 87, 173-178), we believe the active catalyst state to be Cu⁺ (in a CU₂O lattice) which is most likely formed by reduction of Cu²⁺ by adsorbed CO. It is then thought that the CO combines with a surface oxygen to form CO₂. Jernigan, G. G.; Somorjai, G. A. J. Catal. 1994, 147, 567-77.

With recent developments in nanoparticle synthesis leading to the ability to control size, reproducibility and structural complexity, it becomes worthwhile and possibly paramount to define specific target structures for the nanoparticles based on an understanding of the mechanism of the reactions occurring at their surfaces. Application of the most sophisticated computational techniques to examine all aspects of chemical behavior on nanoparticles is challenging due to the limitation of computational resources. However, as the facets of the nanoparticles have a well-defined surface geometry, insights from theory and modeling can be obtained from parallel calculations carried out on single crystal surfaces. In addition to our experimental findings we describe the results of calculations of the phase diagram and pathway for CO oxidation on Cu₂O (100), which are in qualitative agreement with our experimental results.

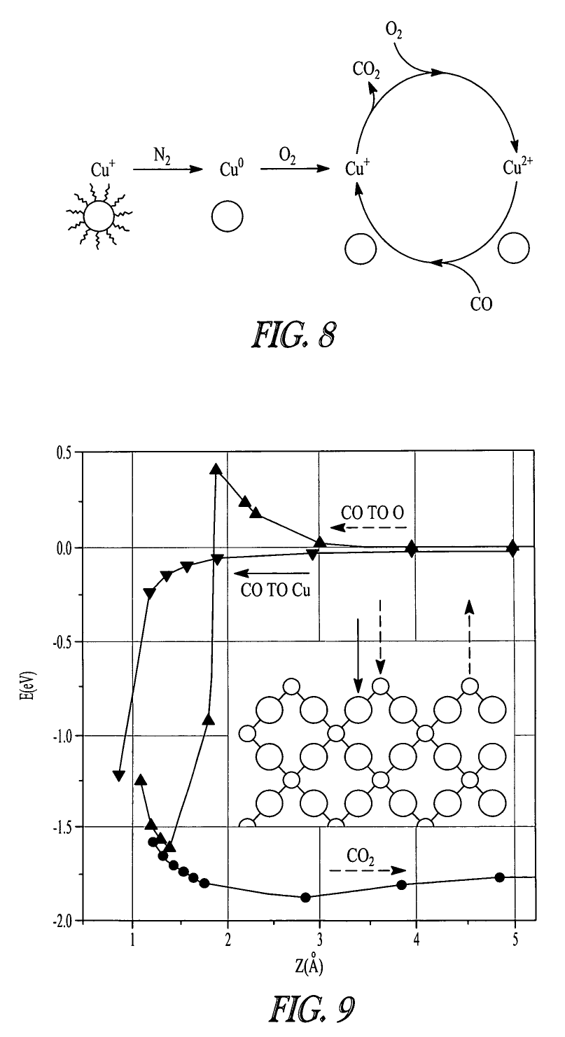

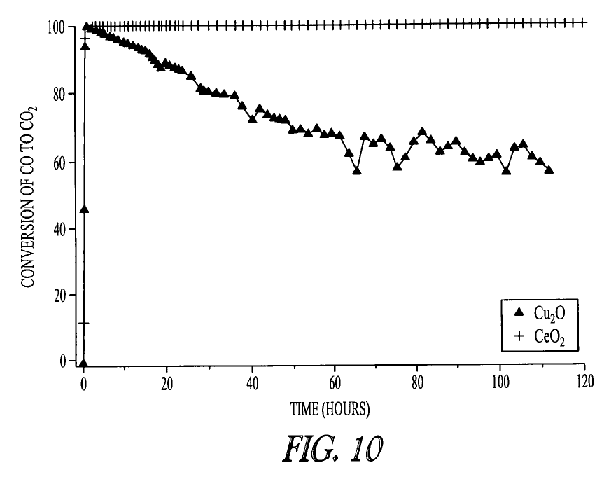

Theoretical calculations suggest that the lattice oxygen, not gas phase oxygen, play a critical role in the CO oxidation process, further verifying the Langmuir-Hinshelwood mechanism. To gain insight into the mechanism of catalytic CO oxidation on Cu₂O, the energetics and pathways for CO adsorption, diffusion and reaction on Cu₂O (100) were calculated, using density functional theory (DFT) with the generalized-gradient approximation for the exchange-correlation functional 30 using the plane wave pseudopotential method. Payne, M. C.; Teter, M. P.; Allan, D. C.; Arias, T. A.; Joannopoulos, J. D. Rev. Mod. Phys. 1992, 64, 1045-1097. To meet the translation symmetry requirement a supercell was built containing a Cu₂O (100) slab and approximately 14 Å of vacuum. The CO behavior was modeled for the O-terminated Cu₂O (100), as it was found to be more stable than Cu-terminated. surface. The slab included alternate O and Cu layers (seven of O and six of Cu), with four atoms in the O layer and eight atoms in the Cu layer. One CO molecule on the surface of the Cu₂O corresponds to a (2×2) unit cell. Ultrasoft pseudopotentials (Vanderbilt, D. Phys. Rev. B: Condens. Matter Mater. Phys. 1990, 41, 7892-7895) were used for all atoms under consideration. The cutoff energy for the plane-wave expansion was 400 eV and Brillouin zonc was sampled with a (7×7×1) k-point mesh. Two reaction pathways were considered for a CO molecule landing on the surface: one where it lands on a surface oxygen atom and another on a surface Cu atom. For both cases the CO trajectories were perpendicular to the surface. The results of calculations are illustrated in FIG. 9.

To land on surface oxygen, CO overcomes an activation barrier of about 0.4 eV. As CO overcomes the barrier and approaches the surface, the energy of the system decreases drastically by ˜2 eV. The CO molecule is found to react with the surface oxygen forming CO₂, which departs spontaneously from the surface (barrierless) creating an oxygen vacancy. On the other hand, if CO lands on a Cu atom, it approaches the surface without any barrier (FIG. 9), diffuses spontaneously to the neighboring surface oxygen, and produces CO₂ as in the earlier step. These calculations attest to the high propensity of CO to oxidize on Cu₂O (100) spontaneously by consuming a surface oxygen. This explains the high catalytic activity of Cu₂O observed even at low temperatures.

The oxygen vacancies created in the course of the CO oxidation will tend to reduce the catalytic activity of the surface. However, the surface oxygen may be restored by dissociative adsorption of gaseous O₂ present in the reaction environment. The O₂ concentration should be high enough to enable restoration of the surface oxygen. At the same time, the concentration of adsorbed oxygen should not exceed the amount at which it starts blocking the active surface sites.

Increased lifetime and activity of the Cu₂O nanoparticles by adding 6 nm CeO₂ nanoparticies is illustrated (FIG. 10). The average activity of Cu₂O nanoparticles over 110 hours is 73%, but by adding 8 mg of 6 nm CeO₂ nanoparticles, the average CO conversion raises to over 99.94%. When only CeO₂ nanoparticles are loaded on silica, the CO conversion yield is very low, <3%.

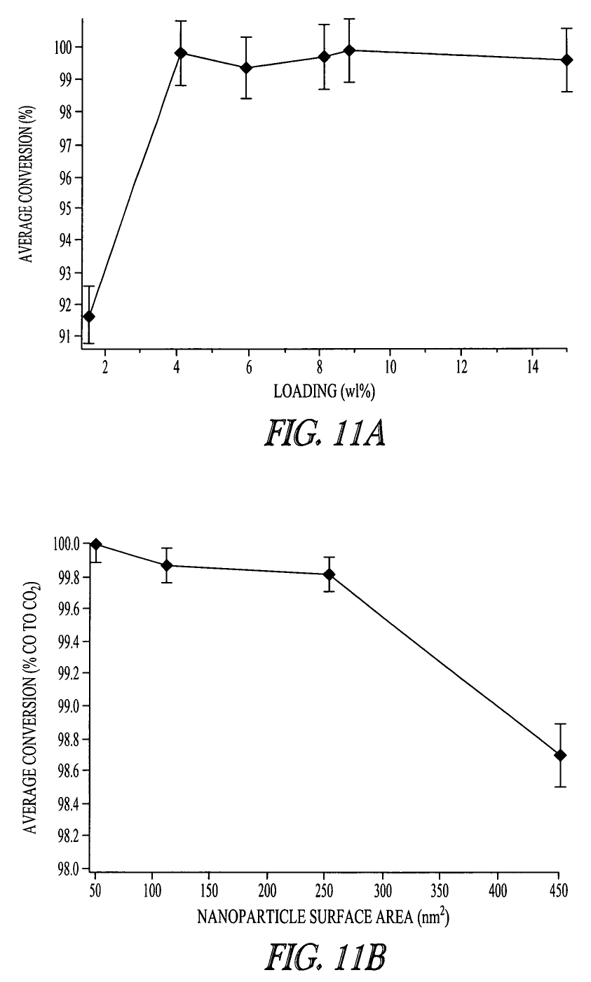

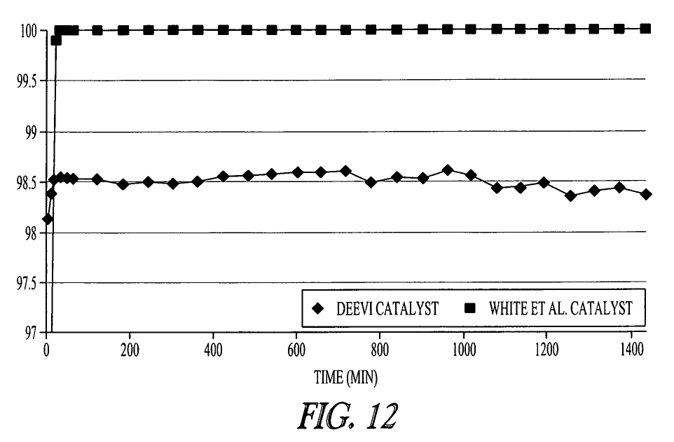

A close study of the Cu₂O and CeO₂ nanoparticle catalyst system shows that several factors influence the efficiency of the CO to CO₂ conversion, two of which are weight percent loading of CeO₂ nanoparticles and the CeO₂ nanoparticle diameter. We found that a 4 wt % to 15 wt % loading of Ce₂O nanoparticles in our catalyst resulted in >99% CO conversion (FIG. 11A), whereas loadings lower than 4 wt % did not supply enough CeO₂ to interact with the Cu₂O in the system.

CeO₂ nanoparticles exhibited a noticeable size dependence on the conversion rate of CO to CO₂ over 120 hours. Using the same loading by weight, increased conversion of CO to CO₂ was observed for decreasing nanoparticle diameter. At first glance one would expect this to be a surface area effect, but a plot of average conversion versus nanoparticle surface area does not result in a linear relationship (FIG. 11B). A nanoparticle surface area of 450 nm² corresponds to a diameter of 12 nm, and 50 nm² corresponds to 4 nm nanoparticles. Similarly prepared CeO₂ nanoparticles with diameters less than or equal to 10 nm have been shown to exhibit a nonzero Ce³⁺ concentration, which increases as diameter decreases.

### Example 8

### Experimental

A comparison of a catalyst described in US 2004/0110633 (“Deevi”) and a catalyst of the presently disclosed subject matter was conducted. A copper-ceria catalyst, as described in Deevi was produced using 5.5 wt % Cu on CeO₂ nanoparticles [226 mg Cu (II) pentanedionate (Alfa Aesar) and 945 mg CeO₂ nanopowder (avg 10-20 nm particles) (from Aldrich)] was produced by annealing under Ar at 375° C. for 45 min, cooling and annealing in air at 380° C. for 1 hour as described ini heat treatment A [see, paragraph 54 of Deevi].

The catalyst powder was then loaded into a continuous flow reactor using quartz wool and heated as described in paragraph 0057 of Deevi. The flow of all the gases was 675 sccm in a ratio of 76:20:4 N₂ to O₂ to CO. As illustrated in the Figures below, the prepared catalyst worked similarly to Deevi's previous work.

Fresh catalyst was then tested under the conditions typically used in the system of the disclosed subject matter. Specifically, catalyst in continuous flow reactor was heated to 240° C. for one hour under N₂ at 240 mL/min. After the heat-up period, 4% CO and 3% O₂ (balance N₂) were introduced into the system, with a total flow of 260 mL/min, corresponding to a gas hourly space volume (GHSV) of ˜80,000 hr⁻¹. Samples of the exhaust were taken approximately every 10 minutes and analyzed for composition of CO, N₂, O₂, and CO₂.

A catalyst of the disclosed subject matter works at a higher conversion for a longer period of time when compared to a catalyst of 10 mg 10 nm Cu₂O nanoparticles mixed with 7 mg of 4 nm CeO₂ nanoparticles on 75 mg of silica gel. See, FIG. 12.

The catalyst of the disclosed subject matter uses nanoparticles over the 4-12 nm range and show size dependence. We synthesized nanoparticles of known monodisperse diameters, and then mixed the nanoparticles together to form the catalyst. Deevi et al. used large cerium oxide particles with a wide range of diameters and then formed copper oxide coatings with no real shape or defined size on the surface of the cerium oxide. Additionally, while Deevi states that nanoparticles were used therein, there is no supporting evidence. In fact, the authors state that the source of the ceria nanoparticles is Alfa Aesar. However, this company sells a product called “Cerium Oxide Nanotek,” which is in the size range 150-850 nm.

Additionally, a catalyst of the disclosed subject matter was found to have a lifetime of about 220 hours. In contrast, the longest lifetimes reported described in Deevi is 20 minutes.

All publications, patents, and patent applications cited herein are incorporated herein by reference in their entirety. While in the foregoing specification this invention has been described in relation to certain preferred embodiments thereof, and many details have been set forth for purposes of illustration, it will be apparent to those skilled in the art that the invention is susceptible to additional embodiments, combinations and sub-combinations; and that certain of the details described herein may be varied considerably without departing from the basic principles of the invention.

1. A nanoparticle system comprising:
(a) a copper oxide nanoparticle comprising:
(i) a core comprising crystalline cuprous oxide (Cu₂O); and
(ii) a shell of amorphous cupric oxide (CuO) present on at least a portion of the surface of the core; and
(b) a spacer, in which the copper oxide nanoparticle is dispersed or supported upon the surface thereof.

2. The nanoparticle system of claim 1, wherein the copper oxide nanoparticles are highly monodisperse, such that the root mean square deviation from the diameter is less than 5%.

3. The nanoparticle system of claim 1, further comprising a surfactant present on at least a portion of the surface of the copper oxide nanoparticle comprising, acid, lauric acid, octanoic acid, stearic acid, 1-octadecanol, elaidic acid, 2-acetyl pyridine, p-anisaldehyde, butyrolactone, 1-formyl piperidine, ethylene carbonate, propylene carbonate, gamma-buytrolactone, catechols, benzylamine oleylamine, or a combination thereof.

4. The nanoparticle system of claim 1, wherein the spacer comprises silica gel, alumina, zeolite, or a combination thereof.

5. The nanoparticle system of claim 1, wherein the spacer comprises silica gel.

6. A catalyst comprising:
(a) a copper oxide nanoparticle comprising:
(i) a core comprising copper-cuprous oxide (Cu^{o}—Cu₂O); and
(ii) cupric oxide (CuO) present on at least a portion of the surface of the core;
(b) optionally a surfactant present on at least a portion of the surface of the copper oxide nanoparticle; and
(c) a spacer in which the copper oxide nanoparticle is dispersed or supported upon the surface thereof.

7. The catalyst of claim 6, wherein the copper oxide nanoparticle has a surface to volume ratio of at least about 250 to about 1500.

8. The catalyst of claim 6, wherein the copper oxide nanoparticle has the structure Cu^{o}—Cu₂O—CuO.

9. The catalyst of claim 6, wherein the copper oxide nanoparticle is a Cu/Cu(I)/Cu(II) oxide nanoparticle.

10. The catalyst of claim 6, wherein the cupric oxide (CuO) has a thickness of up to about 1 nm.

11. The catalyst of claim 6, wherein the copper oxide nanoparticle has a diameter of about 2-40 nm.

12. The catalyst of claim 6, wherein the copper oxide nanoparticle has a diameter of about 4-25 nm.

13. The catalyst of claim 6, wherein the copper oxide nanoparticle is monodisperse, such that the root mean square deviation from the diameter is less than 10%.

14. The catalyst of claim 6, wherein the copper oxide nanoparticle is highly monodisperse, such that the root mean square deviation from the diameter is less than 5%.

15. The catalyst of claim 6, wherein the surfactant is absent.

16. The catalyst of claim 6, wherein the surfactant is present, and is bound to at least a portion of the surface of the copper oxide nanoparticle.

17. The catalyst of claim 6, wherein a monolayer of surfactant is present, and is bound to at least a portion of the surface of the copper oxide nanoparticle.

18. The catalyst of claim 16, wherein the surfactant comprises a compound of the formula:
R¹C(═X)Y
wherein,
R¹ is (C₁₀-C₃₀) alkyl, substituted (C₁₀-C₃₀) alkyl, (C₁₀-C₃₀) alkenyl, substituted (C₁₀-C₃₀) alkenyl, (C₁₀-C₃₀) cycloalkyl, or substituted (C₁₀-C₃₀) cycloalkyl;
X is O, S or NOH; and
Y is OH, O-(C₁₀-C₃₀) alkyl, substituted O-(C₁₀-C₃₀) alkyl, O-(C₁₀-C₃₀) alkenyl or substituted O-(C₁₀-C₃₀) alkenyl,
or a suitable salt thereof.

19. The catalyst of claim 16, wherein the surfactant comprises oleic acid:

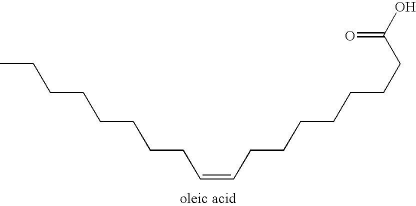

20. The catalyst of claim 6, wherein the spacer comprises silica gel, alumina, zeolite, or a combination thereof.

21. The catalyst of claim 6, wherein the spacer comprises silica gel.

22. The catalyst of claim 6, having a surface area of about 300 m²/g to about 350 m²/g.

23. The catalyst of claim 6, having a pore size of about 280 m²/g to about 600 m²/g.

24. The catalyst of claim 6, having a pore size of about 300 m²/g to about 350 m²/g.

25. The catalyst of claim 6, further comprising at least one additional co-catalyst.

26. The catalyst of claim 6, further comprising at least one additional co-catalyst comprising a metal selected from the group of copper (Cu), chromium (Cr), nickel (Ni), cobalt (Co), iron (Fe), manganese (Mn), platinum (Pt), palladium (Pd), rhodium (Rh), iridium (Ir) and gold (Au).

27. The catalyst of claim 6, further comprising at least one additional co-catalyst comprising a metal selected from the group of platinum (Pt), palladium (Pd), rhodium (Rh), iridium (Ir) and gold (Au).

28. The catalyst of claim 6, further comprising at least one additional co-catalyst selected from the group of CuO, Cu₂O, Mn₃O₄ and CeO₂.

29. The catalyst of claim 6, further comprising CeO₂ as a co-catalyst.

30. The catalyst of claim 6, further comprising up to about 20 wt. % CeO₂ as a co-catalyst.

31. The catalyst of claim 6, further comprising about 4 wt. % to about 15 wt. % CeO₂ as a co-catalyst.

32. The catalyst of claim 24, wherein the co-catalyst is a nanoparticle.

33. A method for oxidizing carbon monoxide (CO) to carbon dioxide (CO₂), the method comprising contacting a catalyst comprising:
(a) a copper oxide nanoparticle comprising:
(i) a core comprising copper-cuprous oxide (Cu^{o}—Cu₂O); and
(ii) cupric oxide (CuO) present on at least a portion of the surface of the core;
(b) optionally a surfactant present on at least a portion of the surface of the copper oxide nanoparticle; and
(c) a spacer in which the copper oxide nanoparticle is dispersed or supported upon the surface thereof;
and a gaseous mixture comprising carbon monoxide (CO) and oxygen (O₂).

34. The method of claim 33, wherein the gaseous mixture comprises carbon monoxide (CO) and oxygen (O₂), in a ratio of at least about 2:1.

35. The method of claim 33, wherein the gaseous mixture further comprises one or more inert gases.

36. The method of claim 33, wherein the gaseous mixture further comprises nitrogen (N₂).

37. The method of claim 33, wherein at least about 99 (v) % of the carbon monoxide (CO) is oxidized to carbon dioxide (CO₂) at a period of time greater than about 12 hours.

38. A method for catalyzing a chemical reaction, the method comprising contacting starting material of the chemical reaction with a catalyst comprising:
(a) a copper oxide nanoparticle comprising:
(i) a core comprising copper-cuprous oxide (Cu^{o}—Cu₂O); and
(ii) cupric oxide (CuO) present on at least a portion of the surface of the core;
(b) optionally a surfactant present on at least a portion of the surface of the copper oxide nanoparticle; and
(c) a spacer in which the copper oxide nanoparticle is dispersed or supported upon the surface thereof;
under suitable conditions effective to catalyze the reaction.

39. A method for manufacturing a catalyst, the method comprising:
(a) contacting a spacer with a nanoparticle, the nanoparticle comprising:
(i) a copper oxide nanoparticle comprising:
(A) a core comprising crystalline cuprous oxide (Cu₂O); and
(B) a shell of amorphous cupric oxide (CuO) present on at least a portion of the surface of the core; and
(ii) a ligand which coats the copper oxide nanoparticle; to form a catalyst precursor;
(b) drying the catalyst precursor to provide a dried catalyst precursor;
(c) heating the dried catalyst precursor, effective to remove the ligand.

40. The method of claim 39, wherein the narioparticle is prepared by the method comprising:
(d) contacting copper acetate, oleic acid and trioctylamine; and heating to provide thermally decomposed copper acetate;
(e) cooling the thermally decomposed the copper acetate to provide cooled particles;
(f) contacting the cooled particles with a solvent, and separating to provide precipitated copper oxide nanoparticles; and
(g) redispersing the precipitated copper oxide nanoparticles.
